(19) United States
(12) Patent Application Publication
(10) Pub. No.: US 2023/0051201 A1
(43) Pub. Date: Feb. 16, 2023

(54) CHARGEABLE ATOMIC BATTERY AND ACTIVATION CHARGING PRODUCTION METHODS

(71) Applicant: ULTRA SAFE NUCLEAR CORPORATION, Seattle, WA (US)

(72) Inventors: Michael John Eades, Seattle, WA (US); Christopher Morrison, Seattle, WA (US); Paolo Francesco Venneri, Seattle, WA (US); Wesley Deason, Seattle, WA (US); Mark Reed, Seattle, WA (US)

(21) Appl. No.: 17/785,690

(22) PCT Filed: Feb. 7, 2021
(86) PCT No.: PCT/US2021/016982

§ 371 Date: Jun. 15, 2022

Related U.S. Application Data
(60) Provisional application No. 62/971,898, filed on Feb. 7, 2020.

(51) Int. Cl. G21H 1/00; G21F 5/015; G21F 5/06

(52) U.S. Cl. CPC G21H 1/00; G21F 5/015; G21F 5/06

(57) ABSTRACT

A chargeable atomic battery (CAB) includes a plurality of CAB units and a CAB housing to hold the plurality of CAB units. Each of the CAB units are formed of a precursor compact including precursor material particles embedded inside an encapsulation material. The precursor material particles include a precursor kernel formed of a precursor material that is initially manufactured in a stable state and convertible into an activated material that is an activated state via atomic irradiation by a particle radiation source. Upon the precursor material being converted, the precursor material is in a partially depleted state such that an initial portion of the precursor material is depleted and a recharge portion of the precursor material is convertible into the activated state via atomic irradiation by the particle radiation source for recharging the chargeable atomic battery.

### CROSS-REFERENCE TO RELATED APPLICATIONS

This application claims priority to U.S. Provisional Patent Application No. 62/971,898, filed on Feb. 7, 2020, titled “Chargeable Atomic Batteries (CABs) enabled by ceramic encapsulation and activation charging production methods enabling cost-effective and scalable radioisotope heaters, electric generators, and x-ray sources,” the entirety of which is incorporated by reference herein.

This application relates to International Application No. PCT/US2021/XXXXXX, filed on Feb. 7, 2021, titled “Chargeable Atomic Battery with Pre-Activation Encapsulation Manufacturing,” the entirety of which is incorporated by reference herein.

### TECHNICAL FIELD

The present subject matter relates to examples of a chargeable atomic battery (CAB) constructed of a generally non-radioactive isotope, and methods for irradiating the CAB via a particle radiation source, allowing the CAB to emit radiation remotely from the particle radiation source, in order to provide emitted radiation energy.

### BACKGROUND

Conventional atomic batteries, sometimes referred to as nuclear batteries or radioisotope generators, typically include Plutonium-238 (Pu-238) or similar “special nuclear material” that can be utilized to manufacture a nuclear weapon. As the Pu-238 radioisotope decays, electricity can be generated from nuclear energy. However, mass commercialization of atomic batteries faces multiple key challenges, including: (1) safety; (2) technical/manufacturing; (3) regulatory framework compliance; and (4) marketability.

Radioisotopes for power production have been in use for nearly 60 years, for example, in the 1960's-1980's low power pacemakers were developed using Plutonium-238 and Promethium-147. When an actinide atom fissions, Strontium-90 is a common by-product. Hence, the Soviet Union mass produced Strontium-90 by processing nuclear fuel and deployed over 1,500 Strontium-90 power units across the Earth and in space. The United States Navy also deployed Strontium-90. However, the Strontium-90 power units faced safety challenges. There have been multiple cases of significant radioactive material release from dilapidated and damaged power units produced by the Soviet Union. Today, power units like the ones produced by the Soviet Union are still a safety liability and are not under consideration as a viable commercial technology.

Following are some of the technical problems in the field of atomic batteries that currently impede commercialization. There is not a robust method of encapsulating and isolating nuclear material from environmental release. Challenges in production and the complexity of containing the nuclear material have also limited the application of atomic batteries. Traditional atomic battery solutions are based on high performance and prohibitively expensive Plutonium-238. The cost, necessarily controlled nature, and limited supply of Plutonium-238 prevent widespread commercial adoption to atomic batteries.

Because of safety concerns, demanding manufacturing requirements, and high regulation, the manufacture and deployment of atomic batteries with Plutonium-238 is complex. The production of Plutonium-238 requires a Neptunium-237 neutron irradiation target. Neptunium-237 is a man-made element that is a controlled special nuclear material. Only a small portion of Neptunium-237 target is converted with each irradiation cycle. This requires the use of chemical methods to dissolve and gather Plutonium-238 and requires significant radiation rated and secure facilities to produce Plutonium-238. Every step of the manufacturing process is closely monitored to ensure safety of human operators and the surrounding community of humans and other living organisms to avoid accidental radiation exposure. Every step is also monitored for national security purposes, in order to avoid unauthorized persons from acquiring special nuclear material. These concerns substantially limit the number of parties capable of manufacturing and transporting atomic batteries. Final recipients deploying the atomic battery, such as customers or other users, need to have in place security protocols to comply with regulations surrounding Plutonium-238, as well as any enrichment facilities needed to fuel or activate the atomic battery. Plutonium-238 is a high-performance atomic battery with a long successful history of deployment for government applications, however due to the issues stated above it cannot be deployed as a commercial technology and the cost of Plutonium-238 limits its use only to the most challenging problems.

Conventional atomic batteries, such as those that operate with Plutonium-238, contain none or very little of the seed material necessary for producing Plutonium-238 and instead use radiochemistry methods to gather the radioactive material. Hence, traditional atomic battery solutions are single-use (without a charging capability)—a radioactive fuel capsule emits subatomic particles, providing energy, until the radioactive material within the fuel capsule has substantially stabilized. Once stabilized, the radioactive material no longer emits enough energy, effectively ending the lifetime (duration of usefulness) of the atomic battery. Once depleted, traditional atomic batteries have similar waste concerns as the nuclear fuel of a nuclear reactor and must be secured and properly stored because of trace amounts of Plutonium-238 and other reactive materials left in the atomic battery.

Utilizing Plutonium-238 constrains the life of an atomic battery to a very specific period. Because Plutonium-238 has a half-life of approximately 88 years, optimizing the size and composition of a Plutonium-238-based atomic battery to a lifespan substantially shorter or longer than 44 years and maintaining consistent radiation output is difficult. Consequently, traditional atomic batteries may need to be retired from service early: after their relatively short mission has been completed, but long before the radioactive battery has substantially stopped emitting radiation. Generally, radioactive material will become inert after approximately 10-20 half-lives. This means that Plutonium-238 is a radiological safety concern for approximately one to two millennia. For shorter-term applications, this is not ideal and limits the utility of Plutonium-238.

Plutonium-238 within traditional atomic batteries emits primarily alpha particles. These alpha emissions have different applications and risk profiles as compared to, for example, beta and gamma particle emissions. Beta and gamma emissions generally penetrate further than alpha emissions, but the beta emissions are generally less damaging to living tissue when inhaled or ingested. Beta and gamma materials emit penetrating x-rays, which can be useful for certain use cases.

### SUMMARY

The various examples disclosed herein relate to nuclear technologies for a chargeable atomic battery system 192 that includes a chargeable atomic battery 190 for space, terrestrial (e.g., land or sea) applications. To improve safety and reusability, the chargeable atomic battery 190 includes CAB units 104A-G formed of precursor material particles 151A-N embedded inside an encapsulation material 152. As opposed to conventional Plutonium-238, the precursor material particles include a precursor kernel 153 formed of a precursor material 159. Precursor material 159 is not a special nuclear material like Plutonium-238 and, unlike Plutonium-238, precursor material 159 is initially manufactured in a stable state that is non-radioactive. Precursor material 159 is rechargeable by a particle radiation source (e.g., nuclear reactor core) 101.

Chargeable atomic battery 190 can possess one-million times the energy density of state-of-the-art chemical batteries and fossil fuel. For locations that do not possess access to the sun or other energy sources, the chargeable atomic battery 190 can generate heat, electrical energy, and passive x-ray radiation sources in a relatively large quantity and in a small form factor. Relevant use cases for the chargeable atomic battery 190 include small satellites operating far from the sun, electronics on the moon attempting to survive the lunar night, underwater vehicles to explore the depths of the ocean, and low-power heat in remote regions, such as Canada, northern Europe, and Asia.

To charge and use a chargeable atomic battery 190, the chargeable atomic battery 190 is placed in proximity to a particle radiation source 101. Subatomic particles 160A-N from the particle radiation source 101 bombard CAB units 104A-G within the chargeable atomic battery 190, irradiating a precursor material 159 selected due to a propensity to convert to a radioactive state under subatomic particle 160A-N bombardment. The precursor material 159 is further selected due to a propensity to convert to a non-radioactive state after releasing radiation particles 161A-N in the radioactive state, and due to a propensity to not transform back into a radioactive state even upon further subatomic particle 160A-N bombardment from a particle radiation source 101. For example, the chargeable atomic battery 190 can be utilized as a radioisotope thermoelectric generator (RTG) that includes thermoelectrics 305 (e.g., an array of thermocouples) to convert the heat released by the decay of the activated material 162 in a radioactive state (e.g., activated state) into electricity by the Seebeck effect. The RTG can be used in a space exploration application, for example.

An example chargeable atomic battery 190 includes a plurality of CAB units 104A-G. Each of the CAB units 104A-G are formed of a precursor compact 158 that includes precursor material particles 151A-N embedded inside an encapsulation material 152. The precursor material particles 151A-N include a precursor kernel 153 formed of a precursor material 159 that is initially manufactured in a stable state and convertible into an activated material 162 that is an activated state via atomic irradiation by a particle radiation source 101. Chargeable atomic battery 190 further includes a chargeable atomic battery 191 housing to hold the plurality of CAB units 104A-G.

Another example chargeable atomic battery 190 includes at least one CAB unit 104A formed of a precursor material 159 embedded inside an encapsulation material 152. The chargeable atomic battery 190 further includes a chargeable atomic battery housing 191 to hold the at least one CAB unit 104A. The precursor material 159 is initially manufactured in a stable state and convertible into an activated material 162 that is an activated state via atomic irradiation by a particle radiation source 101.

An example chargeable atomic battery fabrication method 600 includes providing a plurality of precursor material particles 151A-N (step 605). The precursor material particles 151A-N include a precursor kernel 153 formed of a precursor material 159 that is initially manufactured in a stable state and convertible into an activated material 162 that is an activated state via atomic irradiation by a particle radiation source 101. The chargeable atomic battery fabrication method 600 further includes mixing the plurality of precursor material particles 151A-N with ceramic powder to form a mixture (step 610). Additionally, the chargeable atomic battery fabrication method 600 further includes placing the mixture in a die (step 615), pressing the mixture in the die to form an unsintered green form (step 616), and sintering the unsintered green form into a CAB unit 104A (step 620).

An example chargeable atomic battery method 700 includes placing a precursor material 159 of a CAB unit 104A in proximity to a particle radiation source 101 (step 710). The chargeable atomic battery method 700 further includes during an initial charging cycle of a chargeable atomic battery 190, converting an initial portion of the precursor material of the CAB unit 104A from a stable state into an activated material 162 that is an activated state via the particle radiation source 101 (step 715). The chargeable atomic battery method 700 further includes emitting radiation from the activated material 162 of the chargeable atomic battery 190 (step 720). The chargeable atomic battery method 700 further includes converting the emitted radiation from the activated material 162 into electrical power via thermoelectrics 305 of the chargeable atomic battery 190 (step 725).

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A illustrates a chargeable atomic battery with multiple CAB units, being charged by free neutron fluence emitted by a nuclear reactor core.

FIG. 1B illustrates a single CAB unit of the chargeable atomic battery of FIG. 1A, built out of an encapsulation matrix encompassing precursor material particles, as well as a detail view of an example precursor material particle.

FIG. 1C illustrates an example precursor material particle being bombarded with the free neutron fluence from FIG. 1B.

FIG. 1D illustrates the now activated precursor material particle from FIG. 1C emitting subatomic particles in response to being bombarded by the free neutron fluence from FIG. 1C.

FIGS. 2A-D illustrate an atom from the example precursor material particle from FIGS. 1B-D being bombarded by a free neutron, changing ionization, and then later emitting a subatomic particle and transmuting into another element.

FIGS. 3A-D illustrate an unused CAB unit being charged by a nuclear reactor core, then creating electricity, as well as the relative percentages of select elements within the CAB unit.

FIGS. 4A-D illustrate a previously used but depleted CAB unit being fully recharged by a nuclear reactor core, then creating electricity until the battery is completely and permanently expended, as well as the relative percentages of select elements within the CAB unit.

FIGS. 5A-B illustrate a chargeable atomic battery with coupled thermoelectrics having an individual CAB unit charged by a nuclear reactor core separately from the housing of the chargeable atomic battery.

FIGS. 5C-D illustrate return of the charged CAB unit to the chargeable atomic battery and attachment of a radiation shield.

FIG. 6 is a flowchart depicting a chargeable atomic battery fabrication method for manufacturing an unused, uncharged, chargeable atomic battery.

FIG. 7 is a flowchart depicting the process for initially charging, using, and recharging and reusing a chargeable atomic battery.

FIG. 8 is a flowchart streamlining FIGS. 6 and 7 to illustrate the selection, manufacturing, activation, and power production steps.

FIG. 9 is a chart of activated isotopes, their half-lives, parent isotopes, and power output over a range of days.

Parts Listing

| | |
|---|---|
| 101 | Particle Radiation Source (e.g., Nuclear Reactor Core) |
| 101A-N | Particle Radiation Sources |
| 104A-G | CAB Units |
| 107 | Nuclear Reactor |
| 112 | Filling |
| 150 | Encapsulation Matrix |
| 151A-N | Precursor Material Particles |
| 152 | Encapsulation Material |
| 153 | Precursor Kernel |
| 154 | First Precursor Encapsulation Coating |
| 155 | Second Precursor Encapsulation Coating |
| 156 | Third Precursor Encapsulation Coating |
| 157 | Fourth Precursor Encapsulation Coating |
| 158 | Precursor Compact |
| 159 | Precursor Material |
| 160A-N | Subatomic (e.g., Neutron) Particles |
| 161A-N | Radiation (e.g., Beta) Particles |
| 162 | Activated Material or Radionuclide (e.g., Thulium-170) |
| 163 | Decayed Material |
| 190 | Chargeable Atomic Battery |
| 191 | Chargeable Atomic Battery Housing |
| 192 | Chargeable Atomic Battery System |
| 201 | Precursor Atom (e.g., Thulium-169) |
| 203 | Depleted Atom (e.g., Ytterbium-170) |
| 305 | Thermoelectrics |
| 505 | Radiation Shield |
| 600 | Chargeable Atomic Battery Fabrication Method |
| 700 | Chargeable Atomic Battery Method |
| 800 | Chargeable Atomic Battery Life Cycle Method |
| 900 | Precursor Material Performance Chart |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The term “approximately,” “significantly,” or “substantially” means that the parameter value or the like varies up to ±25% from the stated amount.

The orientations of the chargeable atomic battery 190, associated components, and/or any chargeable atomic battery system 192 incorporating the chargeable atomic battery 190, CAB units 104A-G, or precursor material particles 151A-N, such as shown in any of the drawings, are given by way of example only, for illustration and discussion purposes. In operation for a particular chargeable atomic battery 190, the components may be oriented in any other direction suitable to the particular application of the chargeable atomic battery 190, for example upright, sideways, or any other orientation. Also, to the extent used herein, any directional term, such as lateral, longitudinal, up, down, upper, lower, top, bottom, and side, are used by way of example only, and are not limiting as to direction or orientation of any chargeable atomic battery 190 or component of the chargeable atomic battery 190 constructed as otherwise described herein.

The mass number of an element is denoted in two interchangeable formats. In one mass number format, the mass number is appended to the element name or symbol via a hyphen (e.g. Plutonium-238 or Pu-238). In a second mass number format, the mass number prepends the element name or symbol in superscript (e.g. ²³⁸Plutonium or ²³⁸Pu.) Both formats may appear in the same figures and associated detailed description paragraphs, and no special significance should be placed upon the use of a particular mass number format. Mixed mass number formats (e.g. figure elements labeled “Pu-238” with an associated detailed description paragraph reciting “²³⁸Plutonium”) does not indicate a special significance or relationship when compared to non-mixed mass number formats.

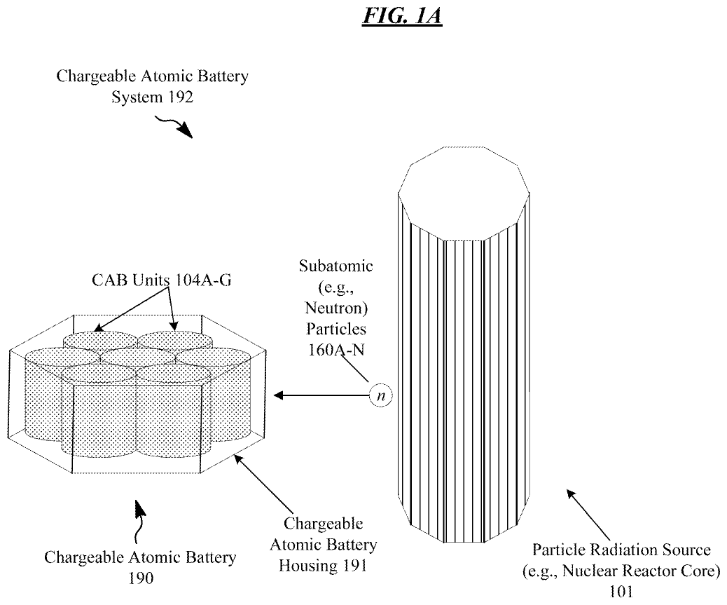

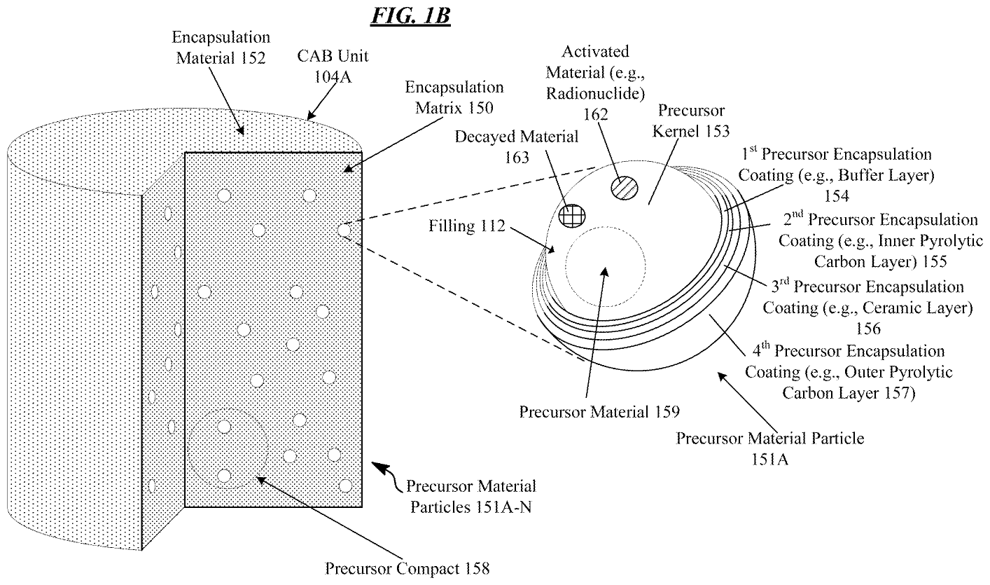

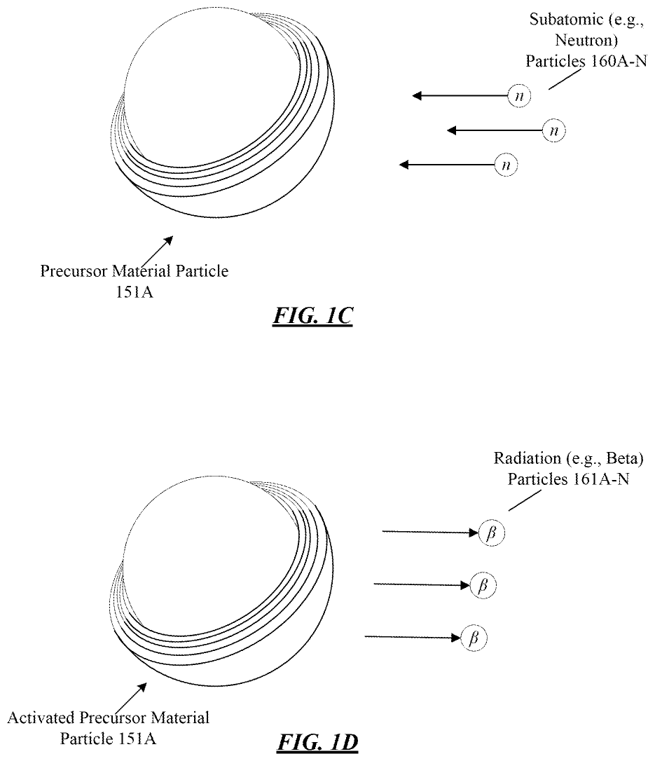

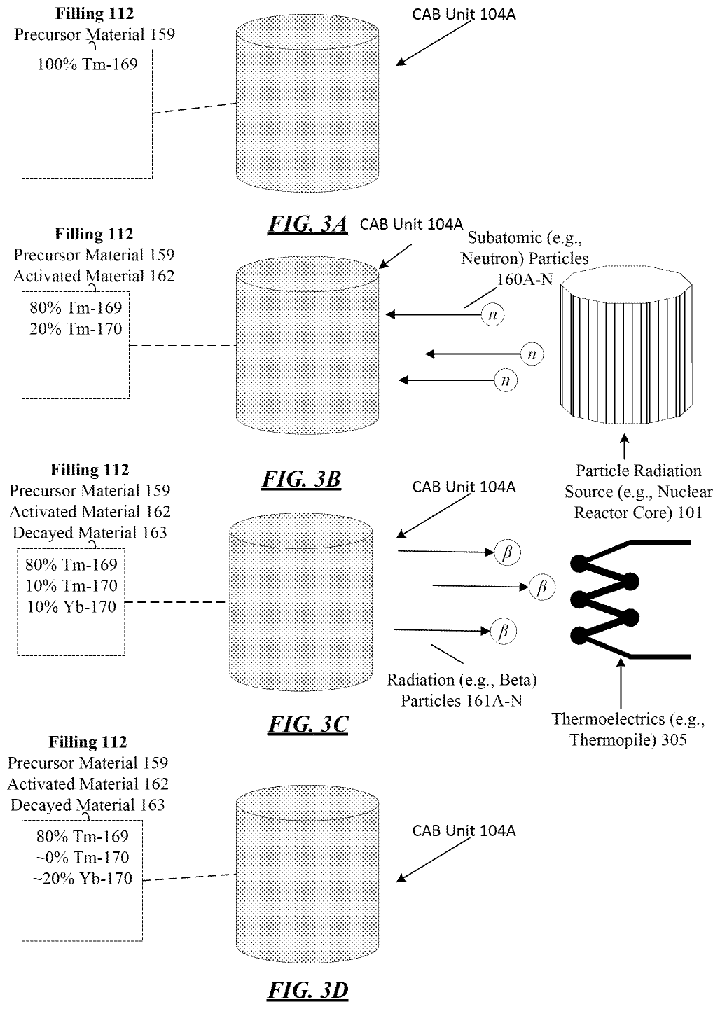

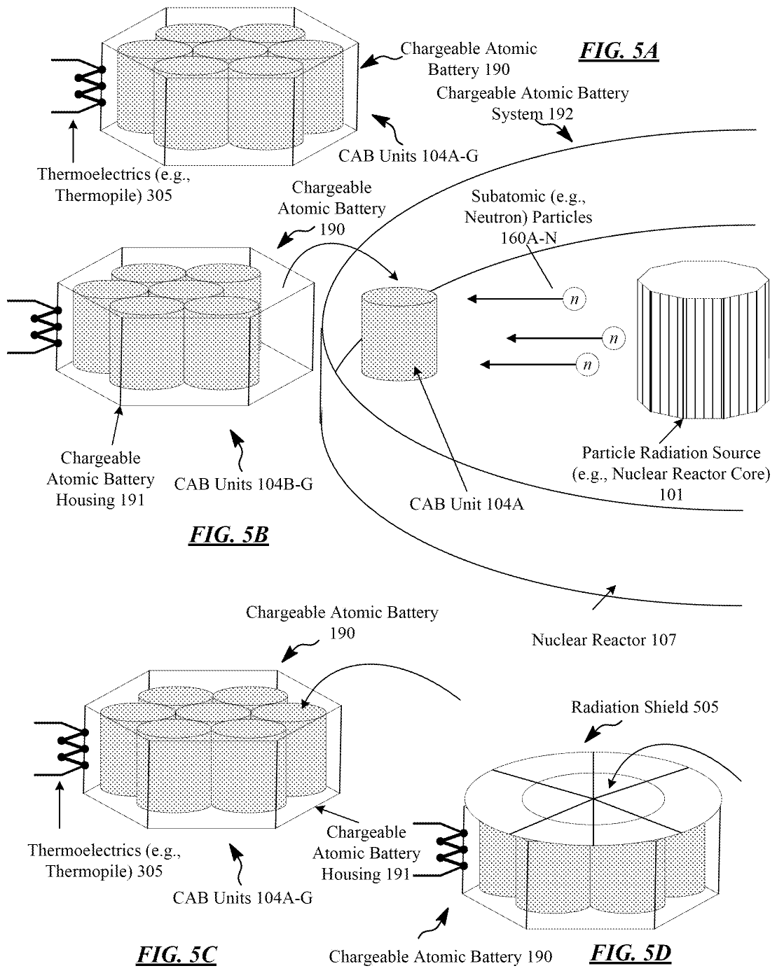

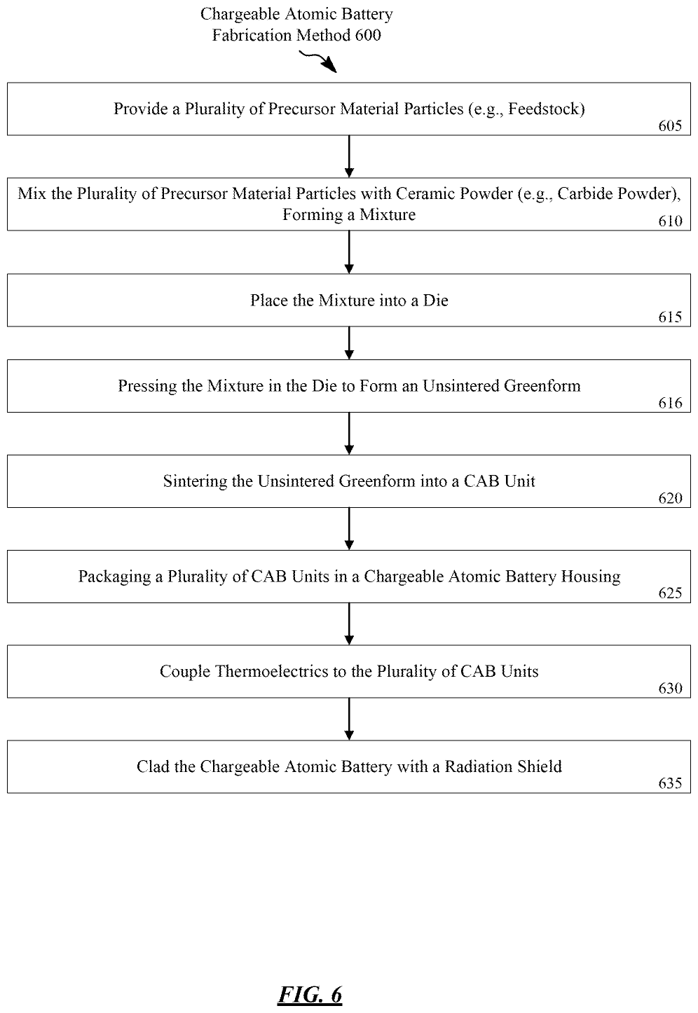

FIG. 1A depicts a chargeable atomic battery system 192 that includes a chargeable atomic battery 190. As shown, chargeable atomic battery 190 includes a plurality of CAB units 104A-G and a chargeable atomic battery housing 191. As shown in the example of FIG. 1A, seven CAB units 104A-G are placed within a chargeable atomic battery housing 191 to hold the CAB units 104A-G. The chargeable atomic battery 191 can enclose or otherwise cover (e.g., partially or fully) the CAB units 104A-G and is selectively openable during: (i) initial charging when the precursor material 159 of the CAB units 104A-G is in a stable state; and (ii) recharging when the precursor material 159 of the CAB units 104A-G is in a partially depleted state and still convertible into an activated state by undergoing irradiation by a particle radiation source 101. The chargeable atomic battery housing 191 is selectively closable when the precursor material 159 of the CAB units 104A-G is charged and in the activated state. The number of CAB units 104A-G of the chargeable atomic battery 190 can vary, e.g., the chargeable atomic battery 190 can include one, two, three, four, five, six, seven, or more CAB units 104A-G. The chargeable atomic battery housing 191 is a structure used to aid in storing, transporting, securing, and retrieving energy from the CAB units 104A-G. Additionally, later figures depict the chargeable atomic battery housing 191 as an appropriate location to attach electrical elements (e.g., thermoelectrics 305 like that shown in FIG. 3) and a radiation shield 505 like that shown in FIG. 5. The radiation shield 505 is a protective covering that can include a rigid heat shield shell to protect from heat, radiation, pressure, etc. In one example, the radiation shield 505 can be formed of an aluminum honeycomb (e.g., hexagonal prismatic walls) shaped structure sandwiched between graphite-epoxy face sheets covered by a layer of phenolic honeycomb (e.g., benzene). The phenolic honeycomb is filled with an ablative material that dissipates heat, such as cork wood, binder and many tiny silica glass spheres. The backshell can be formed like the heat shield, but the backshell may be thinner than the heat shield.

A vehicle (e.g., spacecraft) can include the chargeable atomic battery 190 and an aeroshell attached to the vehicle to protect from heat, radiation, pressure, etc. which can be created by drag during atmospheric entry or reentry of a vehicle. The aeroshell can include the radiation shield 505.

Chargeable atomic battery 190 is placed within range of subatomic particles 160A-N being emitted by a particle radiation source 101. In this example, the particle radiation source 101 is a nuclear reactor core of a nuclear reactor 107 (see FIG. 5B). The chargeable atomic battery 190 is shown next to the nuclear reactor core within a nuclear reactor 107. In the example, the particle radiation source 101 is a nuclear reactor 101 and, as the chargeable atomic battery 190 resides within range of the subatomic particles 160A-N being emitted by the particle radiation source 101, the CAB units 104A-G are bombarded with subatomic particles 160A-N. Alternative particle radiation sources 101A-N can include more generalized fission reactors, fusion reactors, and particle accelerators. A fission reactor splits a heavy nucleus into two or more lighter nuclei, releasing kinetic energy, gamma radiation, and free neutrons. A fusion reactor combines two lighter atomic nuclei to form a heavier nucleus, while releasing energy. A particle accelerator is a machine that uses electromagnetic fields to propel charged particles to very high speeds and energies, and to contain them in well-defined beams.

Chargeable atomic battery housing 191 may induce free neutron 160A-N bombardment (see FIG. 1C), in some examples by being partially lined with a neutron reflector material. Alternatively, the CAB units 104A-G can be removed from the chargeable atomic battery housing 191 to facilitate more direct exposure of the CAB units 104A-G to the subatomic particles 160A-N, or to protect the chargeable atomic battery housing 191 from being unduly exposed to subatomic particles 160A-N from the particle radiation source 101 and potentially experiencing radiation brittling. As the CAB units 104A-G are exposed to the subatomic particles 160A-N, the precursor material 159 within the precursor material particles 151A-N (see FIG. 1B) is exposed to those same subatomic particles 160A-N (see FIG. 1C). Chargeable atomic battery housing 191 can include a body and lid formed of a non-radioactive material, such as graphite, carbon fiber, carbon bonded carbon fiber, or aluminum.

During an initial charging cycle and a recharge cycle, the chargeable atomic battery 190 is placed inside the particle radiation source 101. As noted above, the particle radiation source 101 can be a nuclear reactor 107, such as a light water nuclear reactor or a heavy water nuclear reactor, which include a nuclear reactor core inside of a pressure vessel. The chargeable atomic battery 190 can be placed in the middle of the pressure vessel (e.g., within the nuclear reactor core) or a reflector region (e.g., an inner reflector region or an outer reflector region) of the pressure vessel. In the light water nuclear reactor, the chargeable atomic battery 190 can be placed in the middle (e.g., center) of the nuclear reactor, for example, the chargeable atomic battery 190 can be interspersed with the CAB units of the nuclear reactor core. In another example, the chargeable atomic battery 190 can be placed within an outer reflector region in a periphery of the pressure vessel during the initial charging cycle and the recharge cycle. An example nuclear reactor 107 suitable as a particle radiation source 101 and that includes a pressure vessel, nuclear reactor core, fuel elements, inner reflector region, and outer reflector region is disclosed in U.S. Patent Pub. No. 2020/0027587, published Jan. 23, 2020, titled “Composite Moderator for Nuclear Reactor Systems,” the entirety of which is incorporated by reference herein.

Unlike a traditional atomic battery, the chargeable atomic battery 190 advantageously does not need to be placed in a hot cell before the initial charging cycle. After the initial charging cycle of the chargeable atomic battery 190, a hot cell can be utilized for examination and handling of the chargeable atomic battery 190 between recharge cycles. However, if a waiting period (e.g., time duration) is selected such that the gap time between recharge cycles is sufficiently long enough to enable radiation decay of the precursor material 159 to a safe level, then the hot cell may not be required for handling of the chargeable atomic battery 190.

A hot cell is a shielded nuclear radiation containment chamber and is separate from the particle radiation source 101. The hot cell can be formed of stainless steel 316, polyvinyl chloride (PVC), Corian®, concrete, etc. The amount and penetrating power of radioactivity present in the radioisotopes of the precursor material 159 prescribe how thick the shielding of the hot cell is. Manipulators, such as a tongs, or a remote manipulator (e.g., telemanipulator), are utilized for the remote handling of the chargeable atomic battery 190 inside of the hot cell during the recharge cycle, if the hot cell is used. The telemanipulator allows an operator to work remotely in a high radiation environment. The telemanipulator is operable to open or close the lid of the chargeable atomic battery 190 to load a subset or all of the CAB units 104A-G after being irradiated in a radiation source 101. The telemanipulator is also operable to unload a subset or all of the CAB units 104A-G for irradiation by the radiation source 101.

Telemanipulator can include a mechanical, electrical, hydraulic control device, or a combination thereof (e.g., electromechanical control device) operable to control the lid (e.g., door) of the chargeable atomic battery 190 after the initial charging cycle or the recharge cycle. In one example, the telemanipulator can include an actuator (e.g., electromechanical actuator) that is operable to enable an operator to open and close the lid by an imparting an open/close signal. After the chargeable atomic battery 190 is placed inside the particle radiation source 101 for irradiation and the initial charging cycle or recharge cycle is actually completed, the chargeable atomic battery 190 is removed from the particle radiation source 101 and then moved to the hot cell. Once the chargeable atomic battery 190 is inside the hot cell, the operator may then utilize the telemanipulator to close the lid of the chargeable atomic battery 190, for example, by sending a close signal via an electromechanical actuator type of telemanipulator. After the chargeable atomic battery 190 is depleted, prior to the recharge cycle the operator may again utilize the telemanipulator prior to a recharge cycle in order to impart an open signal to the chargeable atomic battery 190 that opens the lid prior to placement of the chargeable atomic battery 190 within the particle radiation source 101.

Although the precursor material 159 is initially manufactured in a stable state and therefore not radioactive immediately after manufacture, after the initial charging cycle a fraction or all of the precursor material 159 is converted into activated material 162, which is radioactive. The hot cell and manipulators can provide safety to a human operator by avoiding exposure to radiation after the initial charging cycle and recharge cycle of the chargeable atomic battery 190 by enabling the lid to be opened or closed remotely. The hot cell and manipulators enable the chargeable atomic battery housing 191 to be openable to uncover the CAB units 104A-F by the operator remotely. Additionally, the chargeable atomic battery housing 191 can be mechanically openable by the operator in a manual manner to uncover the CAB units 104A-G without the hot cell, for example, before the initial charging cycle. The operator can manually open the chargeable atomic battery housing 191 prior to the initial charging cycle or if the gap time between recharge cycles is sufficiently long enough to enable radiation decay of the precursor material 159 to a safe level.

The chargeable atomic battery 190 incorporating the precursor material 159 in the precursor material particles 151A-N can remedy the following deficiencies of traditional atomic batteries. With respect to radiochemistry, manufacturing traditional atomic batteries often requires a significant amount of radiochemical efforts. Traditional materials need to be irradiated and separated in a radiation certified laboratory. Waste products require proper disposal. Some materials, such as Plutonium, are classified as special nuclear materials and require significant security. This complexity drives up cost, especially capital expenditures on facilities which can take many years to make

FIG. 1B is an illustration of a single CAB unit 104A of the chargeable atomic battery 190. Generally, each of the CAB units 104A-G of the chargeable atomic battery 190 are formed of a precursor compact 158 that includes precursor material particles 151A-N embedded inside an encapsulation material 152. In the example, a high-temperature encapsulation matrix 150 is formed of the encapsulation material 152. Hence, the single CAB unit 104A is shown as comprised of precursor material particles 151A-N embedded inside the encapsulation matrix 150 formed of the encapsulation material 152. The encapsulation material 152 can be a high-temperature carbide. Precursor material particles 151A-N can include a precursor kernel 153 surrounded by one or more optional precursor encapsulation coatings 154-157 (e.g., layers). In the example of FIG. 1B, the precursor material particles 151A-N include tristructural-isotropic (TRISO) precursor material particles. Alternatively or additionally, the precursor material particles 151A-N can include bistructural-isotropic (BISO) precursor material particles. TRISO-like coatings may be simplified or eliminated depending on safety implications and manufacturing feasibility. Precursor material particles 151A-N, such as TRISO precursor material particles, are designed to withstand fission product build up inside a nuclear reactor and may not always be beneficial in a radioisotope battery context. Although the precursor material particles 151A-N in the example include coated precursor material particles, such as TRISO precursor material particles or BISO precursor material particles, the precursor material particles 151A-N can include uncoated precursor material particles.

It should be understood that the precursor material 159 does not need to be formed as part of one or more precursor material particles 151A-N embedded inside an encapsulation matrix 150 formed of the encapsulation material 152. As described in International Application No. PCT/US2021/XXXXXX, filed on Feb. 7, 2021, titled “Chargeable Atomic Battery with Pre-Activation Encapsulation Manufacturing,” the entirety of which is incorporated by reference herein, the precursor material 159 can be in a filling 112 inside an interior volume (e.g., cavity) of the encapsulation material 152. A body that includes one or more encapsulation walls can be formed of the encapsulation material 152. The encapsulation walls include one or more exterior (e.g., outer) encapsulation walls and one or more interior (e.g., inner) encapsulation walls. The interior encapsulation walls interface the filling 112 formed of the precursor material 159 (and activated material 162 if converted into an activated state and/or decayed material 163). Interior encapsulation walls surround an interior volume of the encapsulation material 152 that is filled with or lined with the precursor material 159 (and activated material 162 if converted into the activated state and/or decayed material 163). The optional one or more exterior encapsulation walls and the interior encapsulation walls can be continuous or discontinuous surfaces. The body of encapsulation walls can be circular or oval shaped (e.g., a spheroid, cylinder, tube, or pipe). The body of encapsulation walls can be square or rectangular shaped (e.g., cuboid) or other polygonal shape. The one or more interior encapsulation walls of the encapsulation material 152 can be one continuous interior encapsulation wall surrounding the filling of the precursor material 159 (and activated material 162 if converted into the activated state and/or decayed material 163). Alternatively, the one or more interior encapsulation walls formed of the encapsulation material 152 can be a plurality of discontinuous interior encapsulation walls, which depend on the shape of the filling 112 in the interior volume of the encapsulation material 152. If the filling 112 is a spheroid in three-dimensional space, then there is one continuous interior encapsulation wall of the encapsulation material 152 in the interior volume surrounding the precursor material 159. If the filling 112 is a cuboid or polygonal shape in three-dimensional space, then there are a plurality of continuous interior encapsulation walls of the encapsulation material 152 in the interior volume surrounding the precursor material 159.

Hence, the chargeable atomic battery 190 can include at least one CAB unit 104A formed of a precursor material 159 embedded inside an encapsulation material 152. The chargeable atomic battery 190 further includes a chargeable atomic battery housing 191 to hold the at least one CAB unit 104A. The precursor material 159 is initially manufactured in a stable state and convertible into an activated material 162 that is an activated state via atomic irradiation by a particle radiation source 101.

On the left side of FIG. 1B, the CAB unit 104A is depicted with a cutaway section of the precursor compact 158 showing the interior of the encapsulation matrix 150, as well as the precursor material particles 151A-N embedded within the encapsulation matrix 150. Although the precursor compact 158 is shown as a cylinder shape in the example, the precursor compact 158 can be formed into a variety of different geometric shapes. For example, the precursor compact 158 can be a tile, e.g., polygonal shape (e.g., cuboid), spheroid, or other shapes that can include a planar surface, an aspherical surface, a spherical surface (e.g., cylinder, conical, quadric surfaces), a combination thereof, or a portion thereof (e.g. a truncated portion thereof). Alternatively or additionally, the precursor compact 158 can include one more freeform surfaces that do not have rigid radial dimensions, unlike regular surfaces, such as a planar, aspherical, or spherical surface. On the right side of FIG. 1B, an individual precursor material particle 151A is depicted at a larger scale in cutaway, to illustrate the components within the precursor material particle 151A.

As an example, the CAB unit 104A can include a plurality of fuel lateral facets that are discontinuous to form an outer periphery of the precursor compact 158. As used herein, “discontinuous” means that the outer periphery formed by the fuel lateral facets in aggregate do not form a continuous round (e.g., circular or oval) perimeter. The outer periphery includes a plurality of planar, aspherical, spherical, or freeform surfaces. As used herein, a “freeform surface” does not have rigid radial dimensions, unlike regular surfaces, such as a planar surface; or an aspherical or spherical surface (e.g., cylinder, conical, quadric surfaces).

The encapsulation material 152 includes silicon carbide, zirconium carbide, titanium carbide, niobium carbide, tungsten, molybdenum, or a combination thereof. Silicon carbide may be advantageous over the other materials to form the encapsulation material 152 because titanium carbide, niobium carbide, tungsten, molybdenum may have too great of activation cross section. Each of the precursor material particles 151A-N can include one more optional precursor encapsulation coatings 154-157 around a filling 112, such as a precursor kernel 153 in the example. In one example, the precursor material particles 151A-N can include the filling 112, shown as a precursor kernel 153, surrounded by a first precursor encapsulation coating (e.g., porous carbon buffer layer) 154, a second precursor encapsulation coating (e.g., an inner pyrolytic carbon layer) 155, a third precursor encapsulation coating (e.g., a ceramic layer) 156, and a fourth precursor encapsulation coating (e.g., an outer pyrolytic carbon layer) 157.

Of the possible encapsulation material 152 within which to embed the precursor material particles 151A-N that form the nuclear fuel tiles 104A-G, silicon carbide (SiC) offers good irradiation behavior, and good fabrication behavior. SiC has excellent oxidation resistance due to rapid formation of a dense, adherent silicon dioxide (SiO₂) surface scale on exposure to air at elevated temperature, which prevents further oxidation.

Hence, the precursor material particles 151A-N can include a precursor kernel 153 coated with one or more layers surrounding one or more isotropic materials. Unlike a conventional TRISO precursor material particle, these precursor material particles 151A-N are initially manufactured with a radioactively-stable element within a precursor material 159, rather than a radioactive-unstable isotope. For example, rather than having uranium as the core precursor material, the precursor material particles 151A-N are initially manufactured in a stable state and include stable isotopes as the precursor material 159. For example, the precursor material 159 can include thulium, cobalt, erbium, lutetium, or thallium. Alternatively or additionally, the precursor material 159 can include scandium, silver, hafnium, tantalum, iridium, promethium, europium, gadolinium, and terbium. The precursor material 159 may include unaltered elements, or the elements can be synthesized into a carbide or oxide for chemical stability and immobilized within the encapsulation material 152. Additionally, any isotope capable of interacting with external radiation through as reaction pathways, such as absorbing external neutrons, which is then capable of emitting latent radiation into a stable state (which generally means the precursor material 159 then has a stable isotope ratio) may be selected. The isotope can be part of an element, which may be part of a carbide, oxide or molecule that is selected during manufacturing the precursor material 159 is in a stable state, but the selection is convertible into an activated state, generally as an activated material 162 via atomic irradiation by some particle radiation source 101. The activated material 162 is a radionuclide, also referred to as a radioactive nuclide, radioactive isotope, or a radioisotope. The precursor material 159 forming the CAB unit 104A is held among the plurality of CAB units 104A-G in the chargeable atomic battery housing 191.

Additionally, the element, carbide, oxide, or molecule can be selected based on a mission duration of the entire chargeable atomic battery 190. Generally, the half-life of the selected activated material 162 can be approximately as long as the mission duration: this will ensure consistent energy emissions during the entire mission, and generally the precursor material 159 under consideration when activated have half-lives in the range of 100 days to 1,200 years and can be catered to the performance needs of the customer. As used herein, half-life means the time duration that half of the unstable atoms in the activated state undergo radioactive decay.

The mission duration is the length of time required to complete an assignment for which the chargeable atomic battery 190 is purpose-built to complete. For example, the mission duration of the Curiosity Mars Rover was 23 months upon reaching the surface of Mars. Because the chargeable atomic battery 190 emits radiation constantly once activated until depleted, the mission duration can be calculated from the date that activation of the precursor material 159 is completed. Continuing with the Curiosity Mars Rover example, had the Mars Rover been equipped with a chargeable atomic battery 190, the mission of the chargeable atomic battery 190 would be to provide power to the Mars Rover until the mission of the Mars Rover is completed. The required mission duration would have been at minimum 31 months: 23 months to complete the mission of the Mars Rover upon Mars, and an additional eight months during which the Mars Rover, equipped with the activated chargeable atomic battery 190, travels from Earth to Mars. Further, if the chargeable atomic battery 190 was scheduled to wait six months after activation before being launched with the Mars Rover from Earth, the mission duration would have been at minimum 37 months.

To improve neutron absorption, the selected precursor material 159 can have a large enough neutron absorption cross section to stimulate a reaction but small enough to prevent self-shielding. A cross section is between 15 barns to 120 barns will have good performance, and a cross section between 25 barns to 60 barns can be ideal. Materials with a lower thermal cross section absorption can be very effective, such as Cobalt, with a thermal neutron absorption cross section of 37 barns. However, there are many exceptions to this rule. Europium and Lithium, for example, have much larger cross sections (1,000+ barns) and can perform well. If the thermal neutron cross section of the activated material 162 is too large, the precursor material 159 may transmute into another radionuclide typically with a mismatched half-life. This transmutation is known as double activation, and is usually undesirable as it reduces the amount of the desired radioisotope and introduces a new isotope typically with a half-life that is much shorter or much longer than desired. However, Europium and Lithium, for example, have much larger cross sections and can perform well in some examples.

The selected precursor material 159 can be sintered during manufacturing, and therefore a good precursor material 159 withstands a temperature of at least 1,500 Kelvin without undergoing melting during the sintering: this ensures the precursor material 159 remains in the stable state. In terms of operating temperature, the chargeable atomic battery 190 examples can be utilized over a wide range of temperatures—from well below freezing up to and exceeding 1000 Kelvin (726 degrees C. or 1340 degrees F.).

The precursor material 159 selected preferably benefits from being relatively abundant: Some natural elements have several isotopes each with their own cross section and activation isotopes. The precursor material 159 should be relatively easy to work with in terms of its chemical toxicity. Furthermore, the total mass of the precursor material 159 can be relatively small compared to the total mass of the precursor compact 158. In an example, depending on the isotope, the mass of the precursor material 159 can be one-percent (1%) or less of the mass of the precursor compact 158 within the CAB unit 104A. Some precursor materials 159 can be enriched to improve performance. All precursor compacts 158 presented here use natural non-isotopically enriched precursor material 159. However, isotopically enriched precursor materials can be used to obtain a higher concentration of the desired activated isotope. Later figures will demonstrate how the precursor material 159 is converted from a radioactively stable state to a neutron-emitting radioactive state that is an activated material 162.

When the precursor material particles 151A-N are implemented as TRISO precursor material particles, the TRISO precursor material particles 151A-N include four precursor encapsulation coatings (e.g., layers) of three isotropic materials. For example, the four precursor encapsulation coatings can include: (1) a porous buffer layer 154 made of carbon; followed by (2) a dense inner pyrolytic carbon (PyC) layer 155; followed by (3) a binary carbide layer (e.g., ceramic layer 156 of SiC or a refractory metal carbide layer) to retain fission products at elevated temperatures and to give the TRISO precursor material particles 151A-N a strong structural integrity; followed by (4) a dense outer PyC layer 157. The refractory metal carbide layer of the TRISO precursor material particles 151A-N can include at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof. The encapsulation material 152 can be formed of the same material as the binary carbide layer of the TRISO precursor material particles 151A-N.

TRISO precursor material particles 151A-N are designed not to crack due to the stresses or fission gas pressure at temperatures beyond 1,600° C., and therefore can contain the precursor kernel 153 formed of the precursor material 159 in the worst of accident scenarios. TRISO precursor material particles 151A-N are designed for use in high-temperature gas-cooled reactors (HTGR) that include the particle radiation source 101 as a nuclear reactor core and to be operating at temperatures much higher than the temperatures of LWRs. TRISO precursor material particles 151A-N have extremely low failure below 1500° C. Moreover, the presence of the encapsulation material 152 provides an additional robust barrier to radioactive product release.

The encapsulation material 152, and any precursor encapsulation coatings 154-157 of the precursor material particle 151A may all be composed of different chemical compounds. But those chemical compounds should satisfy one or more of the following criteria: high temperature capability; chemical non-reactivity during manufacturing, charging, or operation; mechanical strength; crack propagation resistance; diffusion or other means of radionuclide transfer through grains on grain boundaries resistance; significant degradation of material properties during irradiation or charging resistance; favorable thermodynamic properties (such as thermal conductivity); or a low nuclear activation cross section. These criteria are not exhaustive, and there may be other criteria depending on the application of the chargeable atomic battery 190.

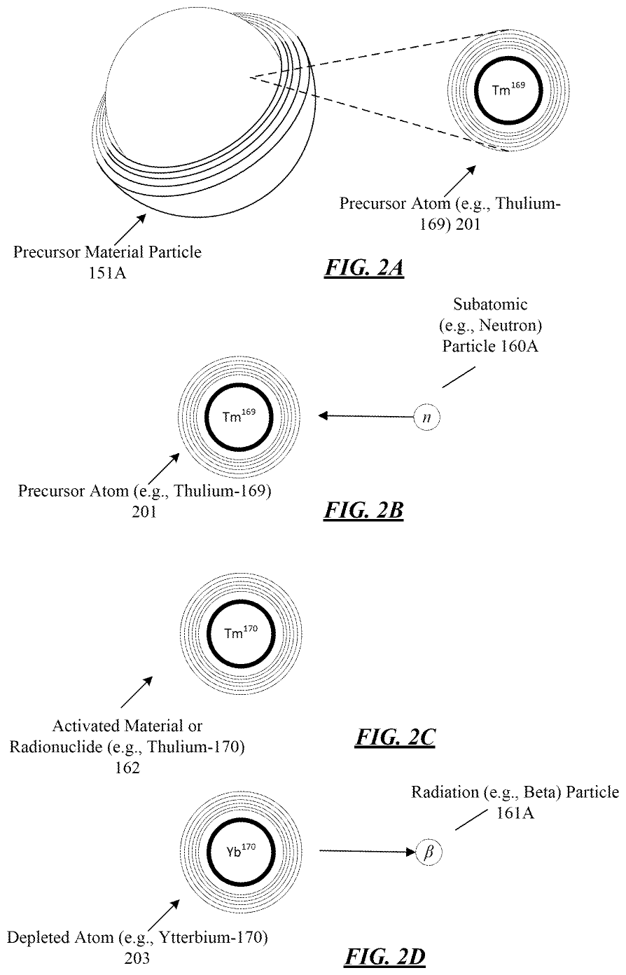

The particle radiation source 101 can be implemented like the nuclear reactor core described in FIG. 2C and the associated text of U.S. Patent Pub. No. 2020/0027587 to Ultra Safe Nuclear Corporation of Seattle, Wash., published Jan. 23, 2020, titled “Composite Moderator for Nuclear Reactor Systems,” the entirety of which is incorporated by reference herein.

Alternatively, the particle radiation source 101 can be a fission reactor: currently available fission reactors can provide high fluxes of neutrons in thermal (energies around 0.253 eV) and to a lesser degree at higher energies up to 1 MeV. HFIR and ATR have produced isotopes such as Pu-238. For nuclear reactions that can be driven by low energy neutrons, fission reactors are excellent choices. Fusion reactors are also contemplated: while not break even in terms of their energy gain, the currently available D-T fusion reactors nevertheless can provide 14.1 MeV neutrons at a moderate flux. In some cases, fusion and fission can be combined into a hybrid reactor to provide a higher neutron flux. Additionally, accelerators are a well-known technology capable of accelerating charged particles to an incredibly high energy. Accelerators can provide a wide range of energies and can provide a beam energy tailored to the correct activation energy of the reaction desired. Accelerated protons, deuterons, and alpha particles can be used directly to produce many radionuclides. Accelerated electrons can produce predictable and controllable level of x-ray and gamma photons through Bremsstrahlung. These photons reactions can then be used to drive nuclear reactions and produce nuclear battery materials. Accelerators are very flexible, but usually suffer from low flux. However, recent advances in accelerator technology from demand in the medial radioisotope industry have yielded potential production methods for significant quantities of radioisotopes.

FIG. 1C depicts an individual precursor material particles 151A being exposed to subatomic particles 160A-N. The subatomic particles 160A-N pass into the precursor compact 158, through the encapsulation material 152, and any outer precursor encapsulation coatings 154-157 of the precursor material particle 151A, striking the precursor material 159. The precursor material 159, having been selected to absorb subatomic particles 160A-N, absorbs some or all of the subatomic particles 160A-N and a portion of the precursor material 159 becomes activated, and radioactive. Not all of the free neutrons emitted by the particle radiation source 101 will irradiate the precursor material 159: some may be blocked, deflected, or absorbed by other materials within the precursor compact 158. The CAB units 104A-G are designed to be placed completely within the radiation range of the particle radiation source 101: the precursor material particle 151A and the precursor material 159 are not separated from the encapsulation material 152, the precursor compact 158, or the CAB unit 104A-G during this radiation exposure process. This bombardment of subatomic particles 160A-N into the precursor material 159 is a charge cycle: the charge cycle can last a variable amount of time, for example one month. The CAB units 104A-G can be charged for multiple cycles or in a higher radiation flux for higher performance levels. In this example, a charge cycle is defined as a one-month irradiation in a typical megawatt scale reactor. The chargeable atomic battery 190 can be charged for multiple cycles or in a higher radiation flux for higher performance levels.

The first time the precursor material 159 is charged of a CAB unit 104A is an initial charging cycle: the particle radiation source 101 converts an initial portion of the precursor material 159 into the activated, radiation-emitting state. Prior to the initial charging cycle, the precursor material 159 is not a radioactive material, which simplifies handling of the chargeable atomic battery 190 in both the supply chain and distribution chain. Because the precursor material 159 is not radioactive prior to the initial charging cycle, applicable government regulations regarding handling, storage, etc. of the chargeable atomic battery 190 are reduced. The portion converted is not easily ascertainable by an observer: subatomic particles 160A-N pass through the precursor compact 158 until they strike an element, ideally one within the precursor material 159. Therefore, the CAB unit 104A does not charge top-to-bottom, front-to-back, or inside-to-outside. The entire CAB unit 104A has a percentage of the precursor material particles 151A-N and accompanying precursor material 159 that are activated and converted into activated material 162, and a percentage of the precursor material particles 151A-N and accompanying precursor material 159 that are stable. Typically, the activated portions and the stable portions cannot be meaningfully identified, segregated, or separated. Moreover, the activated material 162 in the precursor kernel 153 ultimately radioactively decays into a decayed material 163.

Successive chargings of the CAB unit 104A are recharge cycles. In the recharge cycles, the particle radiation source 101 converts a recharge portion of the precursor material 159 into the activated, radiation-emitting state. This recharge portion is separate from the initial portion. The recharge cycle can only irradiate portions of the precursor material 159 that have never been activated: should all of the precursor material 159 within all of the precursor material particles 151A-N in a CAB unit 104A be completely charged then depleted. Then the CAB unit 104A is fully depleted and cannot be recharged again.

Different implementations of the particle radiation source 101 may use varying reaction pathways to irradiate the chargeable atomic battery 190, such as neutron reactions, proton/ion reactions, photon reactions, fission. Neutron activation is the reaction pathway process of a nuclide absorbing a neutron and becoming radioactive (n,γ). There are other reactions such as a (n,2n) or (n,p). The precursor atom 201 in FIG. 2A is an example of the nuclide, and an activated material 162 in FIG. 2C is an example of a nuclide becoming radioactive (radionuclide). Low energy neutrons (0-1 MeV) can be produced in high flux fission reactors and higher energy neutrons can be produced by fusion (<14.1 MeV) or using accelerators, which can produce a very high energy tailored neutron spectrum albeit at a lower flux level. Additionally, high energy proton, deuteron, and alpha particle reactions can interact with a nucleus of a precursor atom 201 to create radioisotopes through absorption, spallation, or other means. Further, photonuclear reactions provide another set of possible atomic reactions that can produce new radioisotopes within the precursor material 159. Recent advances in electron accelerators can produce high-flux high-energy gamma environments through Bremsstrahlung radiation. Several methods for producing medical isotopes have been shown using this method. Still further, a fission reaction produces two radioisotopes. The exact radioisotope produced is dependent upon the nuclide being fissioned and the incident neutron energy. There are many heavy nuclei, which are fissionable and will produce a different set of radioisotopes, providing many potential options for radioisotope production.

FIG. 1D depicts the individual precursor material particle 151A from FIG. 1C, now having been exposed to subatomic particles 160A-N and having become irradiated to be come an activated precursor material particle 151A. Once irradiated, the activated material 162 within the precursor material particle 151A emits radiation particles 161A-N. In this example, the precursor material particle 151A emits beta particles, but alpha particles, gamma particles, and x-rays may all be emitted, depending on which element or molecule is selected for the precursor material 159. Some radiation particles 161A-N (alpha, beta, gamma, x-ray) may be preferred depending on the deployment of the chargeable atomic battery 190. Selecting different activated materials 162 allows for customization of a power format and half-life duration from a wide range of alpha, beta, and gamma radioisotopes that a given precursor material 159 is transformed into when activated.

The radiation particles 161A-N travel away from the CAB unit 104A: by some energy conversion means, either via thermoelectrics 305, Stirling power converters, coolant heating, or nuclear pulse propulsion. These radiation particles 161A-N impart thermal, electrical, or impulse force onto an external system requiring energy, such as satellites, lunar electronics, underwater vehicles, or remote heating devices. Depending on the tolerance for radiation of these energy conversion means and any coupled electronic components, the mass of any radiation shield 505 such as in FIG. 5 required may be greater. A conservative estimate for the tolerance of the electronics is 25 kiloradian (krad) in Silicon. Some electronics can tolerate dose levels in the milliradian (Mrad) range. Techniques such as moving the electronics further from the CAB unit 104A may help reduce required radiation shield 505 mass.

Therefore, FIG. 1A depicts a chargeable atomic battery 190 comprising a plurality of CAB units 104A-G. Each of the CAB units is formed of a precursor compact 158 that includes precursor material particles 151A-N embedded inside an encapsulation material 152. The precursor material particles 151A-N include a precursor kernel 153 formed of a precursor material 159 that is initially manufactured in a stable state and convertible into an activated material 162 that is an activated state via atomic irradiation by a particle radiation source 101. The chargeable atomic battery 190 further comprises a chargeable atomic battery housing 191 to hold the plurality of CAB units 104A-G.

Upon the precursor material 159 being converted, the precursor material 159 is in a partially depleted state such that an initial portion of the precursor material 159 is depleted and a recharge portion of the precursor material 159 is convertible into the activated state via atomic irradiation by the particle radiation source 101 for recharging the chargeable atomic battery 190. During an initial charging cycle, the particle radiation source 101 converts the initial portion of the precursor material 159 into the activated state. During a recharge cycle of the chargeable atomic battery 190, the particle radiation source 101 converts the recharge portion of the precursor material 159 that is different from the initial portion into the activated state. After the initial charging cycle, the activated material 162 has a half-life approximately as long as a mission duration of the chargeable atomic battery 190. The stable state of the chargeable atomic battery 190 is a stable isotope ratio, and the activated state is a radionuclide.

Within the chargeable atomic battery 190, in the stable state or the partially depleted state, the precursor material 159 can include a thermal neutron absorption cross section between 15 to 120 barns, and the precursor material 159 further includes an oxide, a nitride, a carbide, or a combination thereof. In another example, the precursor material 159 can include a thermal neutron absorption cross section of at least 10 barns. In yet another example, the precursor material 159 can include a thermal neutron absorption cross section of at least 50 barns. Additionally, the precursor material 159 withstands a temperature of at least 1,500 Kelvin without undergoing melting during sintering.

The particle radiation source 101 emits subatomic particles 160A-N, and the subatomic particles 160A-N include neutrons, protons, deuterons, alpha particles, high-flux high-energy gamma particles, a fissile atom, or a combination thereof. A chargeable atomic battery system 192 includes the chargeable atomic battery 190 and the particle radiation source 101. The chargeable atomic battery 190 is placed in proximity to the particle radiation source 101, and the particle radiation source 101 converts the precursor material 159 into the activated material 162 while the plurality of CAB units 104A-G are exposed to the subatomic particles 160A-N within the particle radiation source 101. The particle radiation source 101 includes a nuclear reactor 107 such as in FIG. 5. Hence, the chargeable atomic battery 190 is placed within the nuclear reactor 107, and the nuclear reactor 107 converts a portion of the precursor material 159 into the activated state while the plurality of CAB units 104A-G are placed within the nuclear reactor 107. The activated state is a radioisotope. The particle radiation source 101 converts the precursor material 159 into the activated material 162 based on a reaction pathway, and the reaction pathway is neutron activation induced by spallation. The chargeable atomic battery housing 191, radiation shield 505, etc. can be removable components to enable the CAB units 104A-G alone to be placed in the nuclear reactor 107 during an initial charging cycle or a recharge cycle.

The precursor material 159 can be a radioactively-stable nuclide, and in some examples, in the stable state the precursor material 159 includes Thulium-169 (¹⁶⁹Tm). In the activated state, the precursor material 159 is converted into an activated material 162. The activated material 162 includes Thulium-170 (¹⁷⁰Tm). In the activated state, the precursor material 159 can include an alpha emitting isotope, a beta emitting isotope, a gamma emitting isotope, or a combination thereof. The alpha, beta, or gamma emitting isotopes emit the radiation particles 161A-N. In an example, a precursor material mass of the filling 112 of the precursor material 159, activated material 162, and decayed material 163 can be one-percent (1%) or less of an overall mass of the precursor compact 158. The encapsulation material 152 of the chargeable atomic battery 190 can include silicon carbide, zirconium carbide, titanium carbide, niobium carbide, tungsten, molybdenum, or a combination thereof.

FIG. 2A is a depiction of a precursor material particle 151A with detail on a single precursor atom 201 of the precursor material 159. There are multiple similar precursor atoms 201 within the precursor material 159 all behaving similarly, but the behavior of a single precursor atom 201 is shown for illustrative purposes. In this example, the precursor material 159 is Thulium, and so the precursor atom 201 of the precursor material 159 is an atom of Thulium. Thulium-169 is a stable isotope of Thulium, and therefore precursor material 159 made of Thulium-169 is in the stable state, is not radioactive, does not emit radiation particles 161A-N, energy, or force, and can be safely handled and stored. Thulium is an exemplar element, and a variety of elements and molecules can be used in the chargeable atomic battery 190 and will behave in a similar manner with respect to the features emphasized in FIG. 2.

FIG. 2B depicts one of the subatomic particles 160A of the subatomic particles 160A-N in FIG. 1C bombarding the particular precursor atom 201 of Thulium-169. The subatomic particle 160A is a neutron emitted from the particle radiation source 101, and upon striking the precursor atom 201, the subatomic particle 160A joins the nucleus of the precursor atom 201, converting the precursor atom 201 from Thulium-169 to Thulium-170. Thulium-170 is a radioisotope or radionuclide, and has one more neutron than Thulium-169. The precursor atom 201, now transformed into the activated material (radionuclide) 162 at some point will emit radiation as projected based upon the half-life of the activated material 162 of Thulium-170. When the chargeable atomic battery 190 has a substantive amount of Thulium-170 within the precursor material particle 151A, the chargeable atomic battery 190 will create enough energy to provide external power to a coupled system, for example a thermoelectrics 305 like in FIG. 3. Thermoelectrics 305 can include a thermopile, which is an electronic device that converts thermal energy into electrical energy and that includes several thermocouples as an array connected usually in series or, less commonly, in parallel. Thermoelectrics 305 can include heavily doped semiconductors: semiconductors, which have so many free electrons that they have many properties that can generate electricity from the application of a temperature gradient, or vice versa, through the thermoelectric effect. For example, thermoelectrics 305 can include thermoelectric generators, which are solid-state devices that convert heat directly to electricity.

By exploiting this coupling between thermal and electrical properties, thermoelectrics 305 generate electricity from heat flows. A thermoelectric device creates a voltage when there is a different temperature on each side. At the atomic scale, an applied temperature gradient causes charge carriers in the material to diffuse from the hot side to the cold side to generate electricity.

FIG. 2C shows the precursor atom 201 as the activated material (radionuclide) 162 that the precursor atom 201 was converted into. The precursor atom 201 was Thulium-169, and upon absorbing the subatomic particle 160A the precursor atom 201 converted into the activated material 162, a Thulium-170 isotope. In this state, the activated material 162 will eventually emit radiation, and therefore energy, outside of its nucleus.

FIG. 2D shows the activated material (radionuclide) 162 after the activated material 162 has emitted a radiation particle 161A: in this example, Thulium-170 emits primarily beta radiation, so the activated material 162 emits a fast moving electron as the primary radiation particle 161A. Upon the activated material 162 emitting the radiation particle 161A, the activated material 162 changes into a depleted atom 203 of decayed material 163. The depleted atom in this example is decayed material 163 of Ytterbium-170 (¹⁷⁰Yb), which has the same number of neutrons as Thulium-170, and the same number of electrons as Thulium-169. Ytterbium-170 (¹⁷⁰Yb) is a stable isotope of Ytterbium, and will no longer emit radiation. Additionally, the decayed material 163 of Ytterbium-170 cannot be recharged at the particle radiation source 101, and therefore once the filling 112 of the precursor material particles 151A-N are substantially filled with decayed material 163, the CAB unit 104A can no longer be recharged.

FIG. 3A depicts the initial charging process at the CAB unit 104A level. FIG. 3A shows the CAB unit 104A after initial manufacture. The label illustrates that the filling 112 within the precursor material particles 151A-N of the CAB unit 104A are at this time 100% of the precursor material 159 (Thulium-169). This means that the CAB unit 104A is not radioactive, but can be made radioactive by the particle radiation source 101.

FIG. 3B shows the CAB unit 104A near the particle radiation source 101, being bombarded by the subatomic particles 160A-N. As shown, during the initial charging cycle, the filling 112 makeup has changed from 100% precursor material 159 (Thulium-169), to 80% precursor material 159 (Thulium-169), and 20% activated material 162 (Thulium-170).

FIG. 3C illustrates the CAB unit 104A emitting radiation particles 161A-N, in particular at thermoelectrics 305, and with further particularity at a thermopile, for example. Therefore, the chargeable atomic battery 190 further comprises thermoelectrics 305 coupled to the CAB unit 104A to convert radioactive emissions of an activated material 162, such as the radiation particles 161A-N, into electrical power; the thermoelectrics 305 adjust output of the electrical power. That way, any electrical system coupled to the thermoelectrics 305 receives uniform electrical output during the mission duration of the chargeable atomic battery 190. In FIG. 3C, the filling 112 makeup has changed to 80% precursor material 159 (Thulium-169), and 10% activated material 162 (Thulium-170), and 10% decayed material 163 (Yb-170).

FIG. 3D describes the CAB unit 104A after the mission duration has elapsed. The activated material 162 of Tm-170 is significantly depleted into approximately 20% decayed material 163 of Yb-170 now, and the entire CAB unit 104A is in a reduced charge state. There is residual radioactivity based on the half-life. After 10-20 half-lives the activated material 162 would be negligible and the battery would be depleted, which would be much longer than the mission duration. However, initially the stable state was 100% precursor material 159 (Thulium-169), whereas now the filling 112 after 10-20 half-lives is approximately 80% precursor material 159 (Thulium-169) and approximately 20% decayed material 163 (Ytterbium-170). In this state, 20% of the permanent capacity of the CAB unit 104A has been used and the precursor material 159 is 20% partially depleted. However, the chargeable atomic battery 190 still includes 80% of the precursor material 159 (Thulium-169) remaining that can still be activated during recharging.

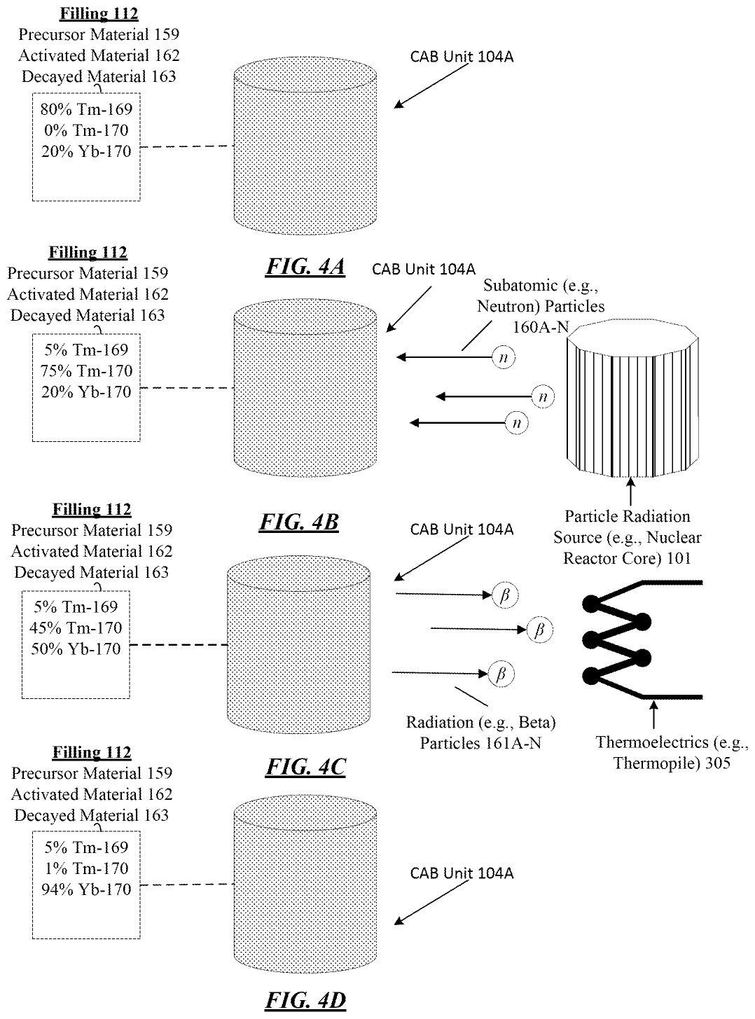

FIG. 4 depicts the recharging process at the CAB unit 104A level. FIG. 4A shows the CAB unit 104A after the effects of FIG. 3D: The labeling illustrates where the filling 112 within the precursor material particles 151A-N of the CAB unit 104A is positioned; this time possessing 80% precursor material 159 (Thulium-169) and 20% decayed material 163 (Ytterbium-170). This means that the CAB unit 104A is not radioactive (after 10-20 half-lives), but can be made radioactive by the particle radiation source 101. The CAB unit 104A can also be placed in the particle radiation source 101 before it is fully depleted (less than 10-20 half-lives) bit will contain some amount of residual radioactivity.

FIG. 4B shows the CAB unit 104A near the particle radiation source 101, being bombarded by the subatomic particles 160A-N. During the recharge cycle, the filling 112 makeup has changed from 80% precursor material 159 (Thulium-169) and decayed material 163 (20% Ytterbium-170), to 5% precursor material 159 (Thulium-169), 75% activated material 162 (Thulium-170), and 20% decayed material 163 (Ytterbium-170).

FIG. 4C illustrates the CAB unit 104A emitting radiation particles 161A-N, in particular at thermoelectrics 305, and with further particularity at a thermopile, for example. As the CAB unit 104A emits radiation particles 161A, the amount of activated material 162 (Thulium-170) decreases and the amount of decayed material 163 (Ytterbium-170) increases at the same rate: at the time of FIG. 3C, there is still 45% activated material 162 (Thulium-170) and 50% decayed material 163 (Ytterbium-170) within the CAB unit 104A. In some examples, this can indicate the chargeable atomic battery 190 is approximately halfway through the full lifespan of the chargeable atomic battery 190. However, as the precursor material 159 is depleted, the precursor material 159 does not charge as well because there are not as many atoms present. A limiting factor can be the mechanical integrity of the chargeable atomic battery 190, which degrades with irradiation.

FIG. 4D describes the CAB unit 104A after the mission duration has elapsed: the activated material 162 is depleted now, and the entire CAB unit 104A is in a stable state. However, the filling 112 is 5% precursor material 159 (Thulium-169), 1% activated material 162 (Thulium-170), and 94% decayed material 163 (Ytterbium-170). Even though the chargeable atomic battery 190 is still slightly radioactive, and has a small amount of precursor material 159 that may be irradiated, the chargeable atomic battery 190 may nevertheless be retired. The entire chargeable atomic battery 190 does not need to be fully depleted before retiring, and in practical use scenarios the chargeable atomic battery 190 is unlikely to be completely used up.

FIG. 5A depicts the charging process of a chargeable atomic battery 190 with a chargeable atomic battery housing 191 capable of decoupling the CAB units 104A-G. FIG. 5A shows the chargeable atomic battery 190 with multiple CAB units 104A-G coupled to thermoelectrics 305. CAB unit 104A is depleted and requires recharging.

FIG. 5B shows the single CAB unit 104A being removed from the chargeable atomic battery housing 191 and being placed within the nuclear reactor 107 near the particle radiation source 101 of the chargeable atomic battery system 192. As shown in FIG. 4B, the single CAB unit 104A is bombarded by subatomic particles 160A-N, which are neutrons emitted by the nuclear reactor core acting as the particle radiation source 101. The chargeable atomic battery housing 191 may not be suited to holding the CAB unit 104A while the CAB unit 104A is charging. This may be due to the thermoelectric 305 having sensitivity to radiation from the particle radiation source 101, or due to the chargeable atomic battery housing 191 having a radiation shield 505. The radiation shield 505 can prevent the CAB units 104A-G from exposing nearby objects to radiation, but that same radiation shield 505 would likely inhibit the subatomic particles from the particle radiation source 101 from reaching the CAB unit 104A efficiently. The radiation shield 505 can be implemented using a high-density material, which is optimal for blocking x-ray radiation. Such materials can include Tungsten and natural or depleted Uranium. For applications where low mass is not a priority, other materials can be used. These shields can be roughly spherical with a cavity for the CAB units 104A-G to be placed inside, for example, in the center.

FIG. 5C illustrates the CAB unit 104A being returned to the chargeable atomic battery housing 191 and thereby the chargeable atomic battery 190. Now, the chargeable atomic battery 190 has the benefit of the recharged CAB unit 104A, without requiring direct exposure to the particle radiation source 101.

FIG. 5D describes placing a radiation shield 505 on the chargeable atomic battery 190. In spaceflight deployments, the spacecraft can include an aeroshell to keep the CAB units 104A-G from being released upon accidental atmospheric reentry during an event such as a rocket launch failure. In some cases, the aeroshell can further protect the spacecraft during atmospheric entry. Such an aeroshell can include the radiation shield 505, protecting any persons or equipment from radiation emitted by the chargeable atomic battery 190. In other examples, the radiation shield 505 may not be as purpose-built as a radioactivity-shielding aeroshell, and may just act as a radiation shield 505 formed as a cladding that encases the plurality of CAB units 104A-G, particularly if the precursor material 159 emits X-rays. In some cases, the aeroshell can serve as additional radiation shielding reducing or eliminating the main radiation shield 505.

Some chargeable atomic batteries 190 emit x-ray or gamma ray radiation, which requires a radiation shield 505. For other types of chargeable atomic batteries 190, no shield is required. Precursor materials 159 that require shielding have higher performance at higher power levels. As noted above, for space applications the radiation shield 505 can double as the aeroshell. For chargeable atomic batteries 190, which require shielding, two dose levels were evaluated: (a) 5 millirem per hour (mrem/hour); and (b) 100 mrem/hour. The 5 mrem/hr dose rate is below the NRC definition of a radiation area and is similar to the dose on the ISS. The 100 mrem/hour dose level is below the NRC definition of a high radiation area with controlled access but would be suitable for contact with electronics and would be accessible to technicians for hour-long periods. For some applications (such as in space) a directional shield can be used to greatly reduce the mass of the shield.

Chargeable atomic batteries 190 with a strong x-ray source can utilize x-ray fluorescence for remote sensing or other applications where radiation can be useful. Additionally, in such chargeable atomic batteries 190 the integral design of the chargeable atomic battery 190 with a radiation shield 505 can enable high flux, well-collimated particle sources. In an example, a vehicle comprises the chargeable atomic battery 190 and an aeroshell. The aeroshell includes the radiation shield 505.

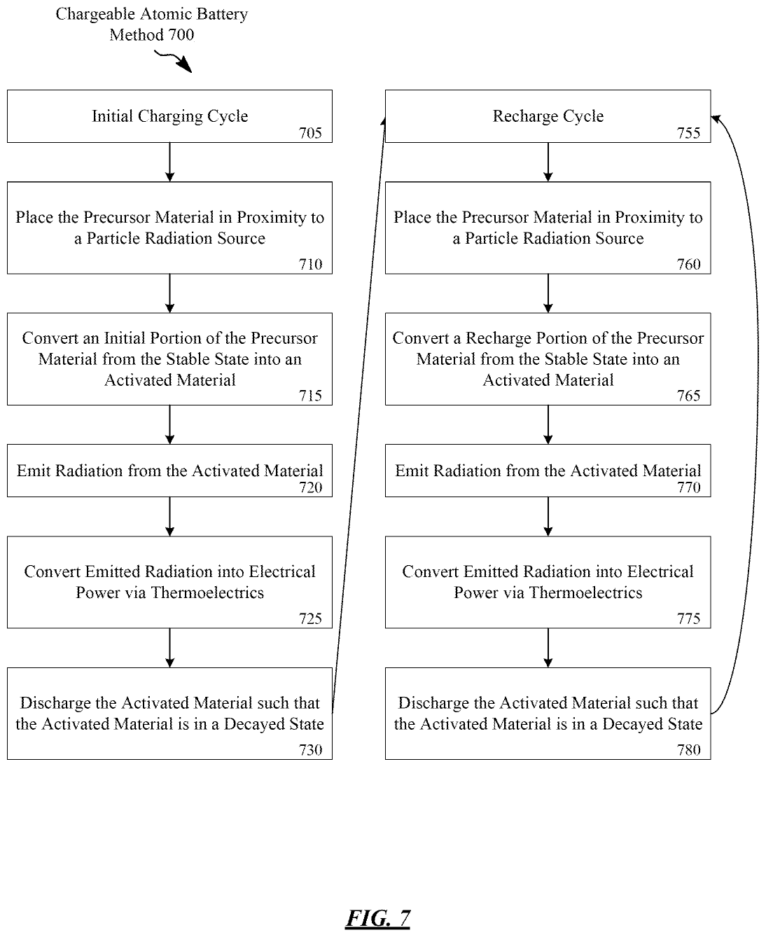

FIG. 6 is a flowchart depicting a chargeable atomic battery fabrication method 600 for manufacturing a chargeable atomic battery 190. In step 605, the chargeable atomic battery fabrication method 600 includes providing a plurality of precursor material particles 151A-N. The precursor material particles 151A-N include a filling 112 (e.g., precursor kernel 153) formed of a precursor material 159 that is initially manufactured in a stable state and convertible into an activated material 162 that is an activated state via atomic irradiation by a particle radiation source 101. In this step 605, and while in the stable state, the precursor material 159 is a radioactively-stable nuclide, and is Thulium-169—once activated, in the activated state, the precursor material 159 is converted into the activated material 162. The activated material 162 includes Thulium-170. The precursor material particles 151A-N include tristructural-isotropic (TRISO) precursor material particles or bistructural-isotropic (BISO) precursor material particles.

Chargeable atomic battery fabrication method 600 further comprises mixing the plurality of precursor material particles 151A-N with ceramic power to form a mixture in step 610. The ceramic powder is the material that forms the encapsulation material 152, and the mixture is the precursor compact 158. The encapsulation material 152 can include silicon carbide, zirconium carbide, titanium carbide, niobium carbide, tungsten, molybdenum, or a combination thereof, and therefore so does the ceramic powder.

In step 615, the chargeable atomic battery fabrication method 600 includes placing the mixture in a die. The die forms the mixture that is the raw precursor compact 158 into the desired shape of the final CAB unit 104A. The mass of the precursor material 159 can be as little as 1% or less of the mass of the overall mixture constituting the raw precursor compact 158. At any point prior to the step of packaging the plurality of CAB units 104A-G in the chargeable atomic battery housing 191, selecting the activated material 162 with a half-life approximately as long as a mission duration of the chargeable atomic battery 190 the CAB unit 104A will eventually be formed into may be performed. This selection can be performed if a particular chargeable atomic battery 190 and mission duration are known. Additionally, prior to the step 605 of providing the plurality of precursor material particles 151A-N, the chargeable atomic battery fabrication method 600 can include selecting the precursor material 159 such that, in the stable state, the precursor material 159 can have a thermal neutron absorption cross section between 15 and 120 barns. In another example, the precursor material 159 has a thermal neutron absorption cross section of at least 10 barns (e.g., Cobalt is 37 barns). In yet another example, the precursor material 159 has a thermal neutron absorption cross section of at least 50 barns. Further, prior to the step 605 of providing the plurality of precursor material particles 605, selecting the precursor material 159 can include selecting an oxide, a nitride, a carbide, or a combination thereof.

In step 616, the chargeable atomic battery fabrication method 600 further includes pressing the mixture in the die to form an unsintered green form. The chargeable atomic battery fabrication method 600 additionally includes a step 620 of sintering the unsintered green form into a CAB unit 104A, for example, applying a current to the die to sinter the mixture into the CAB unit 104A. While a sintering technique, such as spark plasma sintering (e.g., direct current sintering) is an option for sintering in step 620, it should be understood that a furnace, hot pressing, a hot isostatic press (HIP), cold sintering, etc. can also be used for sintering in step 620. The step 620 converts the raw precursor compact 158 into the formed CAB unit 104A. In particular, sintering the mixture into a CAB unit 104A embeds the precursor material particles 151A-N inside an encapsulation material 152 comprised of the ceramic powder, and the CAB unit 104A comprises the precursor material particles 151A-N embedded inside the encapsulation material 152. The sintering can include spark plasma sintering, utilizing direct current sintering to perform eutectic sintering. During sintering, the precursor material 159 does not undergo melting, and the precursor material 159 withstands a temperature of at least 1,500 Kelvin without undergoing melting.

In step 625, chargeable atomic battery fabrication method 600 comprises packaging a plurality of CAB units 104A-G that include the CAB unit 104A in a chargeable atomic battery housing 191 to form the chargeable atomic battery 190, for example, coupling a chargeable atomic battery housing 191 to the plurality of CAB units 104A-G. In one example, the chargeable atomic battery 190 can include a single CAB unit 104A. The step 625 of packaging the plurality of CAB units 104A-G in the chargeable atomic housing 191 to form the chargeable atomic battery 190 includes coupling the chargeable atomic battery 190 to the plurality of CAB units 104A-G such that the chargeable atomic battery housing 191 is openable to uncover the plurality of CAB units 104A-G while the plurality of CAB units 104A-G are exposed to subatomic particles 160A-N within a particle radiation source 101. A chargeable atomic battery housing 191 is coupled to the plurality of CAB units 104A-G to enable the chargeable atomic battery housing 191 to be openable to uncover the plurality of CAB units 104A-G while the plurality of CAB units 104A-G are exposed to subatomic particles 160A-N within a particle radiation source 101. The act of opening the chargeable atomic battery housing 191 can be done manually by an operator opening or closing a lid (e.g., connected by a hinge, sliding mechanism, or push/pull mechanism). Alternatively or additionally, the lid or door can be remotely opened or closed by an operator utilizing a hot cell and manipulators (e.g., telemanipulators), which can be include mechanical, electrical, hydraulic control devices, or a combination thereof, such as electromechanical, to avoid exposure to radiation after the initial charging cycle, as described above.

In step 630 of the chargeable atomic battery fabrication method 600, thermoelectrics 305, such as a thermopile, are coupled to the plurality of CAB units 104A-G, so that once the CAB units 104A-G are initially charged, the thermoelectrics 305 may convert the radioactive energy into electrical energy for electrical systems to utilize. Step 635 of the chargeable atomic battery fabrication method 600 includes cladding the chargeable atomic battery 190 with a radiation shield 505 that encases the plurality of CAB units 104A-G.

FIG. 7 is a flowchart depicting a chargeable atomic battery method 700 for initially charging and for recharging the chargeable atomic battery 190 after the chargeable atomic battery fabrication method 600 in FIG. 6. Once manufactured the chargeable atomic battery 190 is initially non-radioactive. The initial charging cycle begins in step 705, which is followed by placing a precursor material 159 of a CAB unit 104A of a CAB 190 in proximity to a particle radiation source 101 in step 710.

Moving to step 715, the chargeable atomic battery method 700 further includes, during an initial charging cycle of the CAB 190, converting an initial portion of a precursor material 159 of the CAB unit 104A from a stable state into an activated material 162 via the particle radiation source 101. Converting the initial portion of the precursor material 159 of the CAB unit 104A from the stable state into the activated material 162 via the particle radiation source 101 includes exposing the precursor material 159 to subatomic particles 160A-N within the particle radiation source 101 via a reaction pathway. The activated material 162 can have a half-life approximately as long as a mission duration of the CAB 190.

Continuing to step 720, the chargeable atomic battery method 700 includes emitting radiation from the activated material 162 of the CAB unit 104A. In step 720, the CAB 190 is operating after charging, and the radiation emitted as radiation particles 161A-N includes an alpha particle, a beta particle, or a gamma particle.

Next in step 725, the chargeable atomic battery method 700 includes converting the emitted radiation from the activated material 162 into electrical power via thermoelectrics 305 of the CAB 190. Thermoelectrics 305 can convert the emitted radiation from the activated material 162 into electrical power, and provide electrical energy to an external electrical system in need of the thermal energy of the CAB 190.

Moving to step 730, the chargeable atomic battery method 700 includes discharging the activated material 162 until the activated material 162 is converted into a decayed material 163. Proceeding to step 755, the chargeable atomic battery method 700 further includes beginning a recharge cycle provided that the CAB 190 is capable of completing a recharge cycle. Upon the precursor material 159 being converted to the activated material 162, the precursor material 159 is in a partially depleted state. In the partially depleted state, the initial portion of the precursor material 159 is depleted and a recharge portion of the precursor material 159 is still convertible into the activated state via the particle radiation source 101 for recharging the CAB unit 104A. In other words, the CAB 190 is capable of completing the recharge cycle because enough precursor material 159 remains in the filling 112 and the filling 112 is not just the decayed material 163.

Continuing to step 760, the chargeable atomic battery method 700 further includes placing the precursor material 159 of the CAB unit 104A in proximity to the particle radiation source 101. Advancing to step 765, the chargeable atomic battery method 700 further includes during a recharge cycle of the CAB 190, converting the recharge portion of the precursor material 159 of the CAB unit 104A that is different from the initial portion of the precursor material 159 from a stable state into the activated state via the particle radiation source 101. Steps 770, 775, and 780 are the same as steps 720, 725, and 730. Finally, in step 780 of the chargeable atomic battery method 700, when the recharge portion previously converted into the activation state turns into decayed material 163, the recharge cycle is reinitiated in step 755. As long as there is sufficient precursor material 159 left in the filling 112 to enable the CAB 190 to recharge, the recharge cycle will continue. If the filling 112 includes approximately 100% decayed material 163, then the CAB 190 has reached the end of its lifetime.

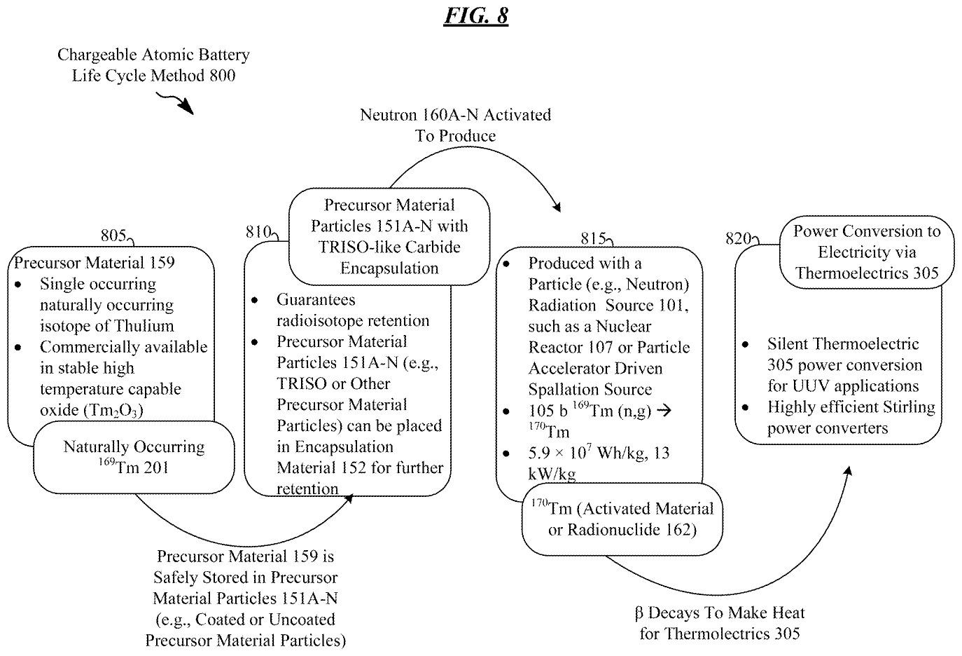

FIG. 8 is a flowchart of a chargeable atomic battery life cycle method 800 streamlining steps of FIGS. 6 and 7 to illustrate the selection, manufacturing, activation, and power production steps. In operation 805 of the chargeable atomic battery life cycle method 800, a naturally-occurring isotope, Thulium-169, is selected to be part of the precursor material 159. When manufactured as an oxide (Tm₂O₃) Thulium-169 (precursor material 159) is stable in high temperatures, as well as relatively plentiful as a naturally occurring isotope, has a thermal neutron absorption cross section of at least 50 barns, and has a half-life of about 100 days when converted into the activated material 162 of Tm-170. For this chargeable atomic battery 190 example, Thulium-169 is a good-fit selection.

In operation 810, the Tm₂O₃ is encapsulated into a TRISO-like particle: this is placing the precursor material 159 within the precursor material particle 151A. TRISO-like encapsulation is an established nuclear technology that grants radioisotope retention. In this example, the TRISO-like particle or precursor material particle 151A is placed in an encapsulation material 152, for further radioisotope retention.

Operation 815 sees the precursor material particle 151A neutron activated. This neutron activation is produced with a particle radiation source 101 or neutron source such as a reactor or accelerator driven spallation source. The precursor material 159 of Thulium-169 is now converted into an activated material 162. The activated material 162 includes Thulium-170, and produces 5.96×107 watt-hours per kilogram, and will produce 13 kilowatts per kilogram as the activated precursor material 159 emits radiation.

Operation 820 shows the benefits of the beta decay of the activated material 162 (Thulium-170) to make heat. The beta decay provides off-the-shelf power conversion via silent thermoelectric power conversion for unmanned underwater vehicle (UUV) applications, and highly efficient Stirling power converters in other applications. Eventually, the activated material 162 becomes decayed material 163.

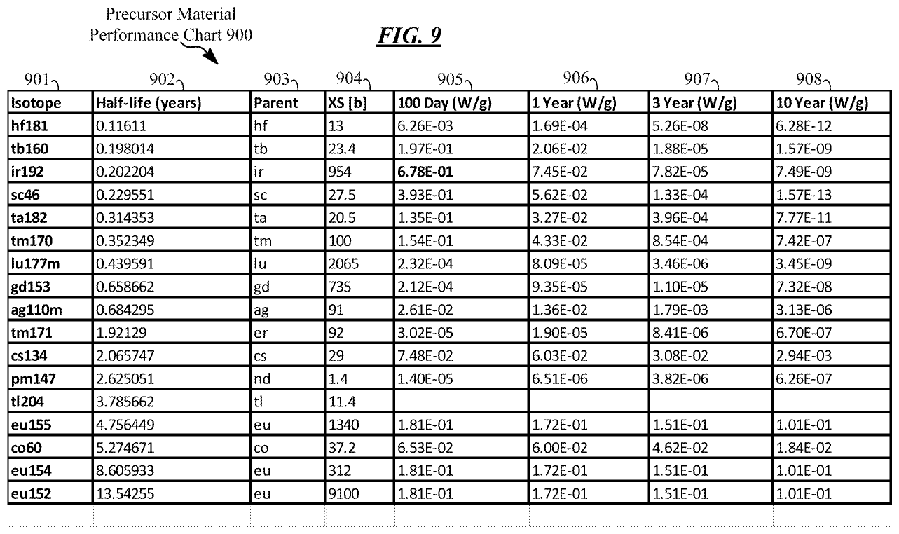

FIG. 9 is a precursor material performance chart 900 of activated isotopes, their half-lives, parent isotopes, and power output over a range of days. Column 901 of the precursor material performance chart 900 identifies the activated material (radionuclide) 162 that will be providing the energy from the chargeable atomic battery 190. Column 902 displays the half-life of that activated material 162 from column 901. In column 903, the parent precursor atom 201 of the activated material 162 from column 901 is shown. Column 904 is the thermal neutron cross section for producing the nuclide in column 901 from the chemical element in column 903. Columns 905-908 of the precursor material performance chart 900 show the electrical output of the activated material 162 from column 901 at various points in time. Column 905 shows the watts per gram output 100 days after irradiation. Column 906 shows the watts per gram output 1 year after irradiation. Column 907 shows the watts per gram output 3 years after irradiation. Column 908 shows the watts per gram output 10 years after irradiation.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A chargeable atomic battery (CAB), comprising:
a plurality of CAB units, each of the CAB units being formed of a precursor compact including precursor material particles embedded inside an encapsulation material,
wherein the precursor material particles include a precursor kernel formed of a precursor material that is initially manufactured in a stable state and convertible into an activated material that is an activated state via irradiation by a particle radiation source; and
a chargeable atomic battery housing to hold the plurality of CAB units.

2. The chargeable atomic battery of claim 1, wherein
upon the precursor material being converted, the precursor material is in a partially depleted state such that an initial portion of the precursor material is depleted and a recharge portion of the precursor material is convertible into the activated state via irradiation by the particle radiation source for recharging the chargeable atomic battery.

3. The chargeable atomic battery system of claim 2, wherein:
during an initial charging cycle of the chargeable atomic battery, the particle radiation source converts the initial portion of the precursor material into the activated state; and
during a recharge cycle of the chargeable atomic battery, the particle radiation source converts the recharge portion of the precursor material that is different from the initial portion into the activated state.

4. The chargeable atomic battery of claim 3, wherein, after the initial charging cycle, the activated material has a half-life approximately as long as a mission duration of the chargeable atomic battery.

5. The chargeable atomic battery of claim 1, wherein:
the stable state is a stable isotope; and
the activated state is a radionuclide.

6. The chargeable atomic battery of claim 1, wherein, in the stable state or a partially depleted state, the precursor material includes a thermal neutron absorption cross section of at least 50 barns.

7. The chargeable atomic battery of claim 6, wherein the precursor material further includes an oxide, a nitride, a carbide, or a combination thereof.

8. The chargeable atomic battery of claim 1, wherein the precursor material withstands a temperature of at least 1,500 Kelvin without undergoing melting during sintering.

9. The chargeable atomic battery of claim 1, wherein:
the particle radiation source emits subatomic particles; and
the subatomic particles include neutrons, protons, deuterons, alpha particles, high-flux high-energy gamma particles, a fissile atom, or a combination thereof.

10. A chargeable atomic battery system, comprising:
the chargeable atomic battery of claim 9; and
the particle radiation source;
wherein:
the chargeable atomic battery is placed in proximity to the particle radiation source, and
the particle radiation source converts the precursor material into the activated material while the plurality of CAB units are exposed to the subatomic particles within the particle radiation source.

11. The chargeable atomic battery system of claim 10, wherein:
the particle radiation source includes a nuclear reactor;
the chargeable atomic battery is placed within the nuclear reactor;
the nuclear reactor converts a portion of the precursor material into the activated material while the plurality of CAB units are placed within the nuclear reactor; and
the activated state is a radioisotope.

12. The chargeable atomic battery system of claim 1, wherein the particle radiation source converts the precursor material into the activated material based on a reaction pathway.

13. The chargeable atomic battery system of claim 12, wherein the reaction pathway is neutron activation induced by spallation.

14. The chargeable atomic battery of claim 1, wherein, in the stable state, the precursor material is a radioactively-stable nuclide.

15. The chargeable atomic battery of claim 14, wherein:
in the stable state, the precursor material includes Thulium-169 (¹⁶⁹Tm);
in the activated state, the precursor material is converted into an activated material; and
the activated material includes Thulium-170 (¹⁷⁰Tm).

16. The chargeable atomic battery of claim 1, wherein:
in the activated state, the precursor material is converted into the activated material; and
the activated material includes an alpha emitting isotope, a beta emitting isotope, a gamma emitting isotope, or a combination thereof.

17. The chargeable atomic battery of claim 1, further comprising:
thermoelectrics coupled to the CAB unit to convert radioactive emissions of an activated material into electrical power.

18. The chargeable atomic battery of claim 7, wherein the thermoelectrics adjust output of the electrical power.

19. The chargeable atomic battery of claim 1, wherein:
the precursor material particles include coated precursor material particles; and
the encapsulation material includes silicon carbide, zirconium carbide, titanium carbide, niobium carbide, tungsten, molybdenum, or a combination thereof.

20. The chargeable atomic battery of claim 19, wherein:
the coated precursor material particles include tristructural-isotropic (TRISO) precursor material particles or bistructural-isotropic (BISO) precursor material particles.

21. The chargeable atomic battery of claim 20, further comprising a radiation shield formed as a cladding that encases the plurality of CAB units.

22. A vehicle, comprising:
the chargeable atomic battery of claim 21; and
an aeroshell that includes the radiation shield.

23. A chargeable atomic battery (CAB), comprising:
at least one CAB unit formed of a precursor material embedded inside an encapsulation material; and
a chargeable atomic battery housing to hold the at least one CAB unit,
wherein the precursor material is initially manufactured in a stable state and convertible into an activated material that is an activated state via irradiation by a particle radiation source.

24. A chargeable atomic battery (CAB) fabrication method, comprising steps of:
providing a plurality of precursor material particles, wherein the precursor material particles include a precursor kernel formed of a precursor material that is initially manufactured in a stable state and convertible into an activated material that is an activated state via irradiation by a particle radiation source;
mixing the plurality of precursor material particles with ceramic powder to form a mixture;
placing the mixture in a die;
pressing the mixture in the die to form an unsintered green form; and
sintering the unsintered green form into a CAB unit.

25. The chargeable atomic battery fabrication method of claim 24, wherein the step of sintering the unsintered green form into the CAB unit includes:
applying a current to the die to sinter the mixture into the CAB unit; and
embedding the precursor material particles inside an encapsulation material comprised of the ceramic powder.

26. The chargeable atomic battery fabrication method of claim 25, wherein:
the encapsulation material includes silicon carbide, zirconium carbide, titanium carbide, niobium carbide, tungsten, molybdenum, or a combination thereof; and
the precursor material particles include tristructural-isotropic (TRISO) precursor material particles or bistructural-isotropic (BISO) precursor material particles.

27. The chargeable atomic battery fabrication method of claim 24, further comprising:
packaging a plurality of CAB units that include the CAB unit in a chargeable atomic battery housing to form a chargeable atomic battery.

28. The chargeable atomic battery fabrication method of claim 27, wherein:
the step of packaging the plurality of CAB units in the chargeable atomic battery housing to form the chargeable atomic battery includes coupling the chargeable atomic battery to the plurality of CAB units such that the chargeable atomic battery housing is openable to uncover the plurality of CAB units while the plurality of CAB units are exposed to subatomic particles within a particle radiation source.

29. The chargeable atomic battery fabrication method of claim 27, further comprising:
coupling thermoelectrics to the plurality of CAB units.

30. The chargeable atomic battery fabrication method of claim 27, further comprising:
cladding the chargeable atomic battery with a radiation shield that encases the plurality of CAB units.

31. The chargeable atomic battery fabrication method of claim 27, further comprising:
prior to the step of packaging the plurality of CAB units in the chargeable atomic battery housing, selecting the activated material with a half-life approximately as long as a mission duration of the chargeable atomic battery.

32. The chargeable atomic battery fabrication method of claim 27, wherein:
the step of packaging the plurality of CAB units in the chargeable atomic battery housing includes coupling the chargeable atomic battery housing to the plurality of CAB units to enclose the plurality of CAB units.

33. The chargeable atomic battery fabrication method of claim 24, wherein:
the step of sintering the unsintered green form into the CAB unit includes direct current sintering, eutectic sintering, or spark plasma sintering.

34. The chargeable atomic battery fabrication method of claim 24, wherein, in the stable state, the precursor material is a radioactively-stable nuclide.

35. The chargeable atomic battery fabrication method of claim 34, wherein:
in the stable state, the precursor material includes Thulium-169 (¹⁶⁹Tm);
in the activated state, the precursor material is converted into the activated material; and
the activated material includes Thulium-170 (¹⁷⁰Tm).

36. The chargeable atomic battery fabrication method of claim 24, wherein a precursor material mass of the precursor material is one-percent (1%) or less of an overall mass of the mixture.

37. The method of fabricating the chargeable atomic battery of claim 24, further comprising:
prior to the step of providing the plurality of precursor material particles, selecting the precursor material where, in the stable state, the precursor material includes a thermal neutron absorption cross section of at least 50 barns.

38. The chargeable atomic battery fabrication method of claim 37, wherein the step of selecting the precursor material includes selecting the precursor material including an oxide, a nitride, a carbide, or a combination thereof.

39. The chargeable atomic battery fabrication method of claim 24, wherein during the step of sintering the unsintered green form into the CAB unit, the precursor material does not undergo melting.

40. The chargeable atomic battery fabrication method of claim 39, wherein during the step of sintering the unsintered green form into the CAB unit, the precursor material withstands a temperature of at least 1,500 Kelvin without undergoing melting.

41. A chargeable atomic battery (CAB) method, comprising steps of:
placing a precursor material of a CAB unit of a chargeable atomic battery in proximity to a particle radiation source;
during an initial charging cycle of the chargeable atomic battery, converting an initial portion of the precursor material of the CAB unit from a stable state into an activated material that is an activated state via the particle radiation source;
emitting radiation from the activated material of the CAB unit; and
converting the emitted radiation from the activated material into electrical power via thermoelectrics of the chargeable atomic battery.

42. The chargeable atomic battery method of claim 41, wherein the radiation emitted includes an alpha particle, a beta particle, or a gamma particle.

43. The chargeable atomic battery method of claim 41, further comprising:
discharging the activated material until the activated material is converted into a decayed material.

44. The chargeable atomic battery method of claim 41, wherein:
upon the precursor material being converted, the precursor material is in a partially depleted state such that the initial portion of the precursor material is depleted and a recharge portion of the precursor material is convertible into the activated state via the particle radiation source for recharging the CAB unit.

45. The chargeable atomic battery method of claim 44, further comprising:
during a recharge cycle of the chargeable atomic battery, converting the recharge portion of the precursor material of the CAB unit that is different from the initial portion of the precursor material from a stable state into the activated state via the particle radiation source.

46. The chargeable atomic battery method of claim 41, wherein:
the activated material has a half-life approximately as long as a mission duration of the chargeable atomic battery.

47. The chargeable atomic battery method of claim 41, wherein:
the step of converting the initial portion of the precursor material of the CAB unit from the stable state into the activated material includes exposing the precursor material to subatomic particles within the particle radiation source via a reaction pathway.
